(19) United States
(12) Patent Application Publication
(10) Pub. No.: US 2010/0146380 A1
(43) Pub. Date: Jun. 10, 2010

(54) Apparatuses, Methods and Systems For An Information Comparator Preview Generator

(75) Inventors: Armand Rousso, New York, NY (US); Steven Schwartz, Brooklyn, NY (US)

Correspondence Address: CHADBOURNE & PARKE LLP, 30 ROCKEFELLER PLAZA, NEW YORK, NY, 10112, US

(73) Assignee: ACCOONA CORP., Jersey, NJ (US)

(21) Appl. No.: 12/443,031

(22) PCT Filed: Sep. 26, 2007
(86) PCT No.: PCT/US07/79592

§ 371 Date: Jan. 22, 2010

Related U.S. Application Data
(60) Provisional application No. 60/827,049, filed on Sep. 26, 2006.

(51) Int. Cl. G06F 3/048; G06F 17/00

(52) U.S. Cl. 715/234; 715/760

(57) ABSTRACT

An information comparator preview generator that provides interfaces for generating information comparison previews for use in the comparison of advertising that is attractive, easy to navigate and straightforward Such comparison presentations allow consumers to compare and/or navigate through related and/or competing information and/or advertisements side-by-side In one embodiment, the information comparator preview generator allows an advertiser to generate a preview (e g, ad) from an existing web page

### RELATED APPLICATIONS

Applicants hereby claim priority under 35 USC §119 for U.S. provisional patent application No. 60/827,049 filed Sep. 26, 2006 and titled “APPARATUSES, METHODS AND SYSTEMS FOR AN INFORMATION COMPARATOR.” The entire contents of the aforementioned application is herein expressly incorporated by reference.

Applicants hereby expressly incorporate by reference the U.S. provisional patent application No. 60/805,698 filed Jun. 23, 2006 and titled “APPARATUSES, METHODS AND SYSTEMS TO GENERATE, DISPLAY AND USE A SEARCH ENHANCING NAVIGATOR.”

Applicants hereby expressly incorporate by reference the Patent Cooperation Treaty (PCT) patent application serial no. PCT/US06/13873 filed Apr. 12, 2006 titled “APPARATUSES, METHODS AND SYSTEMS TO IDENTIFY, GENERATE, AND AGGREGATE QUALIFIED SALES AND MARKETING LEADS FOR DISTRIBUTION VIA AN ONLINE COMPETITIVE BIDDING SYSTEM.”

Applicants hereby expressly incorporate by reference the PCT patent application serial no. PCT/05/20545 filed Jun. 10, 2005, entitled “APPARATUS, METHOD AND SYSTEM OF ARTIFICIAL INTELLIGENCE FOR DATA SEARCHING.”

### FIELD

The present disclosure is directed generally to apparatuses, methods, and systems relating to electronic search and comparison, and more particularly, to apparatuses, methods and systems to generate, display and utilize information comparison preview generators.

### BACKGROUND

Current electronic advertising paradigms include pay-for-placement, pay-for-ranking, pay-for-performance (P4P) and pay-per-click (PPC) models. These models present online advertisements such as banner ads and text links to web surfing users. For example, in a PPC model, when ad viewers click on the ads, the clicks are registered and the advertiser is charged for a user having engaged the advertisement. In other words, advertisers pay a cost-per-click (CPC) for users that engage online advertising. Other online advertising models may also employ banner ads and text links and may charge for impressions. In the pay-per-impression model, if an ad is rendered with a text page for display to a user, the advertiser is charged under the assumption that a user may have viewed the advertisement and is thereby exposed to the goods/services offered by the advertisement.

### SUMMARY

Current electronic search and advertising systems do not provide systems for creating comparison previews, information items and/or ads that are as user-friendly, easy to navigate and straightforward as the disclosed information comparator preview generator. Current advertising systems serve a particular ad for a particular ad campaign. In contrast, in one embodiment the disclosed information comparator allows advertisers to present one or more different ads in a comparison context. As more and more information is placed on the web, and as more and more news and business entities make their information available on the internet, the conventional method of supplying search tokens and ordering results without comparative context hinders web users' efforts to evaluate competing information sources. As such, web users may be frustrated in that it is difficult or impossible to make meaningful comparisons and evaluations regarding information.

The disclosed information comparator preview generator provides interfaces for generating information comparison previews (e.g., information items and/or ads) for use in the comparison of information. The information comparator preview generator enhances search mechanisms, research, advertising and comparisons regarding information, news, advertising, and/or the like. Further, the information comparator preview generator provides a mechanism for creating information items that making information searches and/or advertisements more efficient and meaningful.

The preview generator may, in some embodiments, allow sources (e.g., advertisers, creators, owners, and/or operators of websites hosting content) to generate information items (e.g., ads). For example, in one implementation, the information comparator preview generator could be provided as a tool or utility that allows advertisers and/or the like to select, create and/or generate information items from existing media, such as web sites. The information items may then be stored and used in subsequent comparison presentations provided to consumers (e.g., web users).

### BRIEF DESCRIPTION OF THE DRAWINGS

The accompanying appendices and/or drawings illustrate various non-limiting, example, inventive aspects in accordance with the present disclosure:

FIG. 1 provides a mixed data and logic flow overview of an embodiment of the information comparator;

FIG. 1A provides an interaction overview for some embodiments of the information comparator;

FIG. 1B provides an overview flow diagram for an embodiment of the information comparator;

FIGS. 1C-1D provide a process flow diagram illustrating aspects of an embodiment of the information comparator;

FIG. 1E provides an overview of comparison presentation data structure in an embodiment of the information comparator;

FIG. 2A provides a flow diagram for an implementation of one embodiment of the information comparator;

FIG. 2B illustrates an implementation of an embodiment the information comparator;

FIG. 2C provides an overview of an embodiment of the information comparator;

FIG. 2D provides a flow diagram illustrating an interface aspect for an embodiment of information comparator;

FIG. 3A is a screen image diagram illustrating an interface aspect of one embodiment of the information comparator;

FIG. 3B is a wire frame diagram illustrating embodiments of the information comparator engagement component;

FIG. 4A is a screen image diagram illustrating embodiments of the information comparator selection component;

FIG. 4B is a wire frame diagram illustrating embodiments of the information comparator selector component;

FIG. 5A provides a screen image diagram illustrating an alternative embodiment of the information comparator selector component;

FIG. 5B provides a wire frame diagram illustrating an alternative embodiment of the information comparator selector component;

FIG. 6 is of a wire frame diagram illustrating an embodiment of the information comparator;

FIG. 7A provides an interface interaction flow diagram for an embodiment of the information comparator;

FIG. 7B provides a flow diagram illustrating an aspect of user interaction analysis in an embodiment of the information comparator;

FIG. 8A provides a process flow diagram illustrating an aspect of advertiser interaction for an embodiment of the information comparator;

FIG. 8B illustrates additional aspects of an embodiment of the information comparator;

FIG. 8C provides a flow diagram illustrating aspects of an embodiment of the information comparator;

FIG. 9A is of a screen image diagram illustrating aspects of preview generation for an embodiment of the information comparator;

FIG. 9B provides a process flow diagram illustrating aspects of preview generation for an embodiment of the information comparator;

FIG. 10 is of a block diagram illustrating a system controller for embodiments of the information comparator.

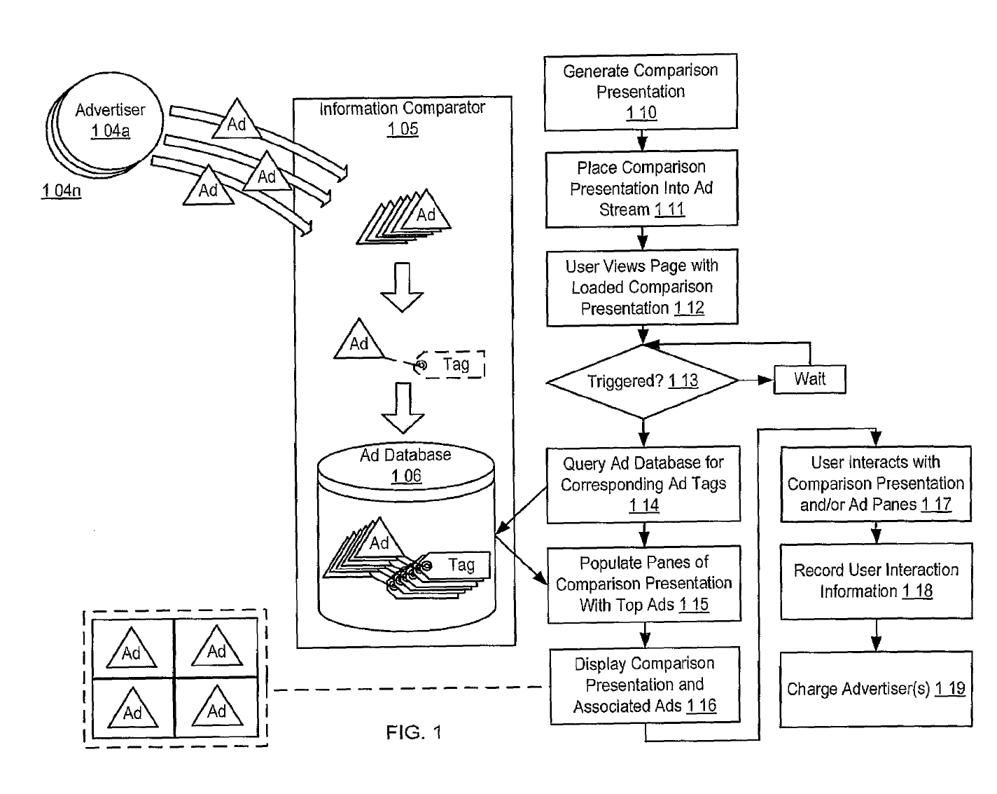

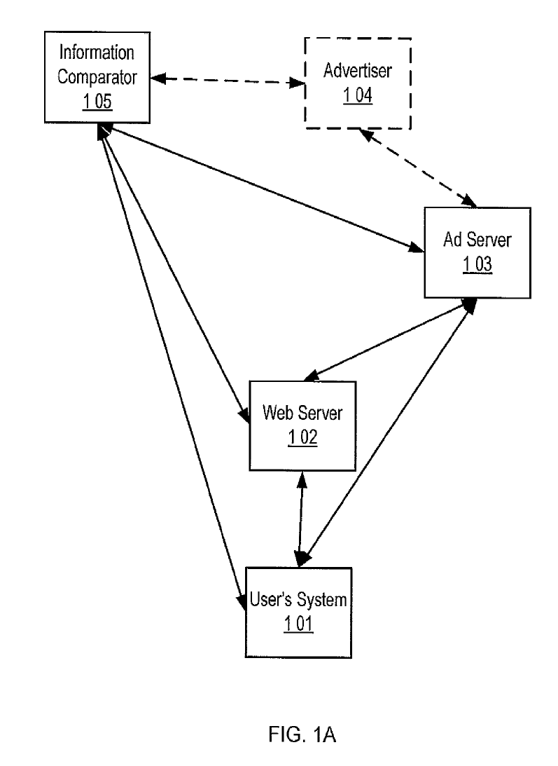

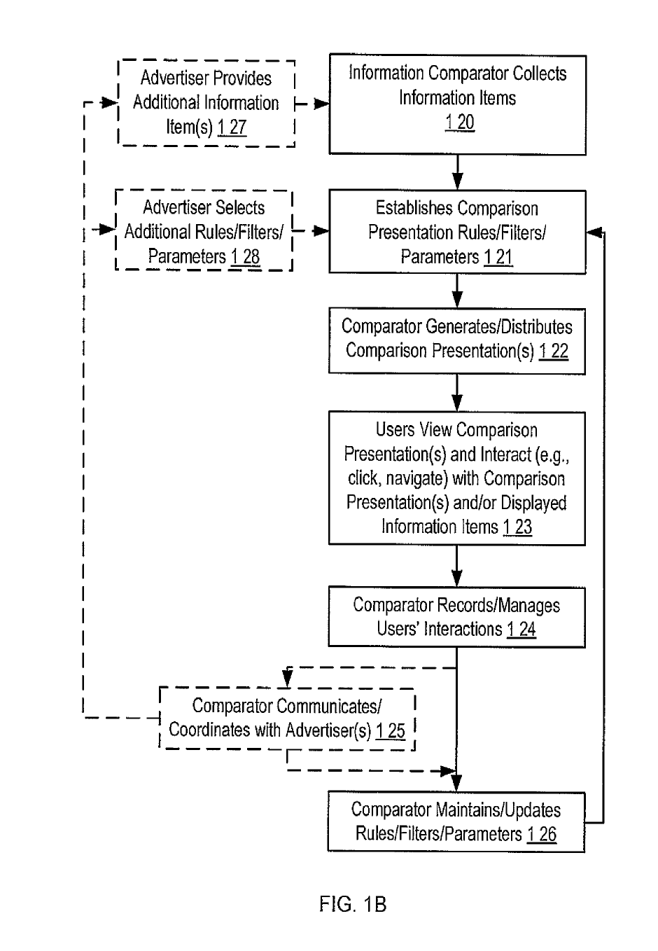

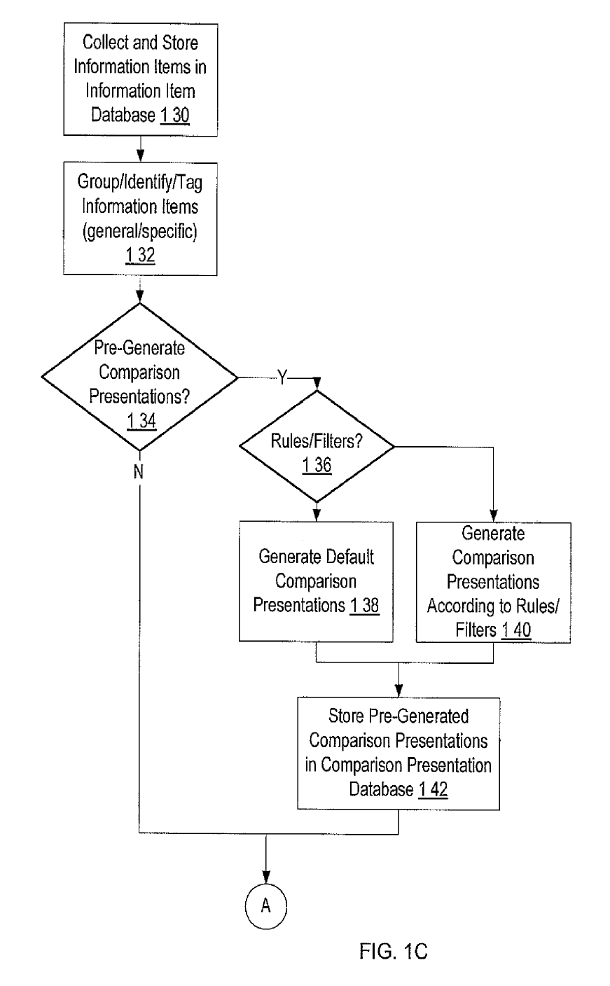

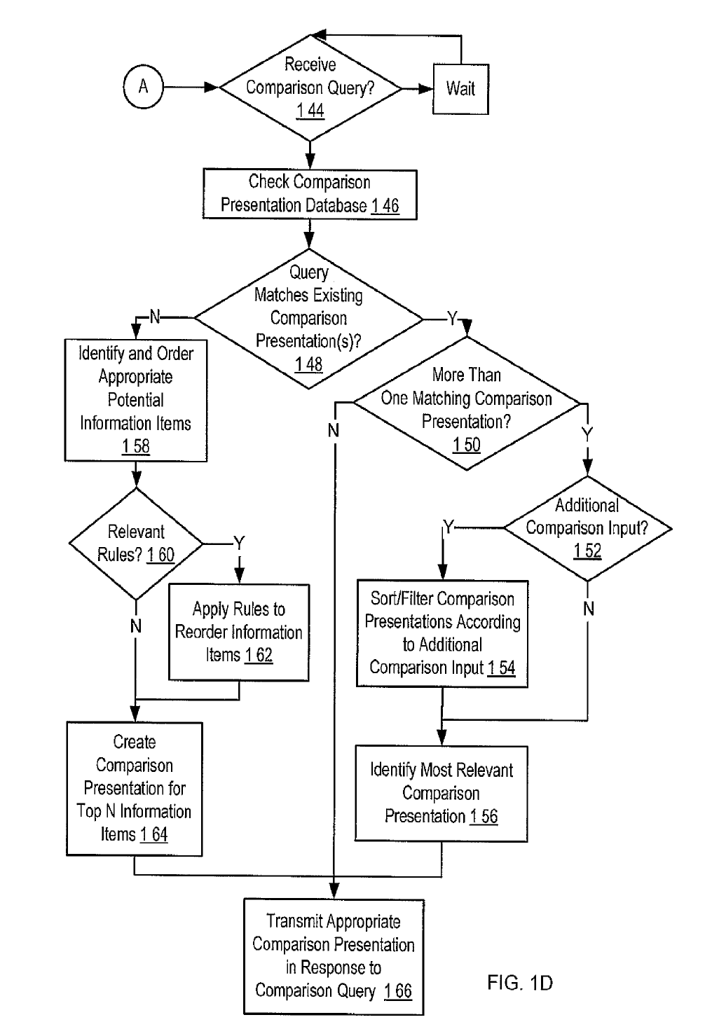

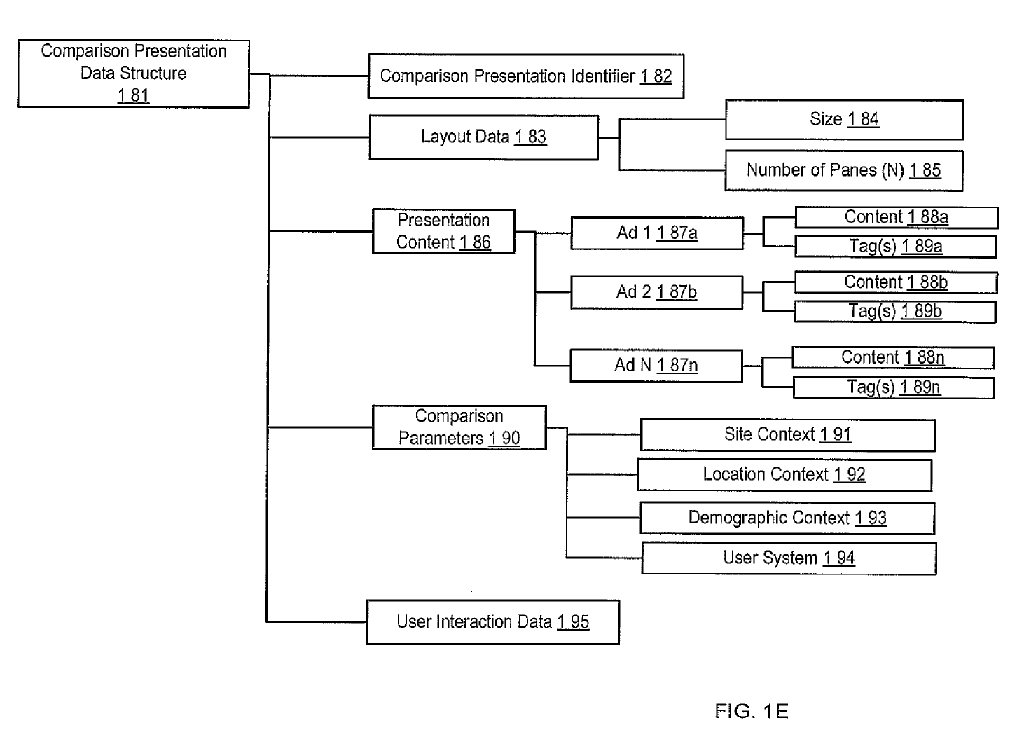

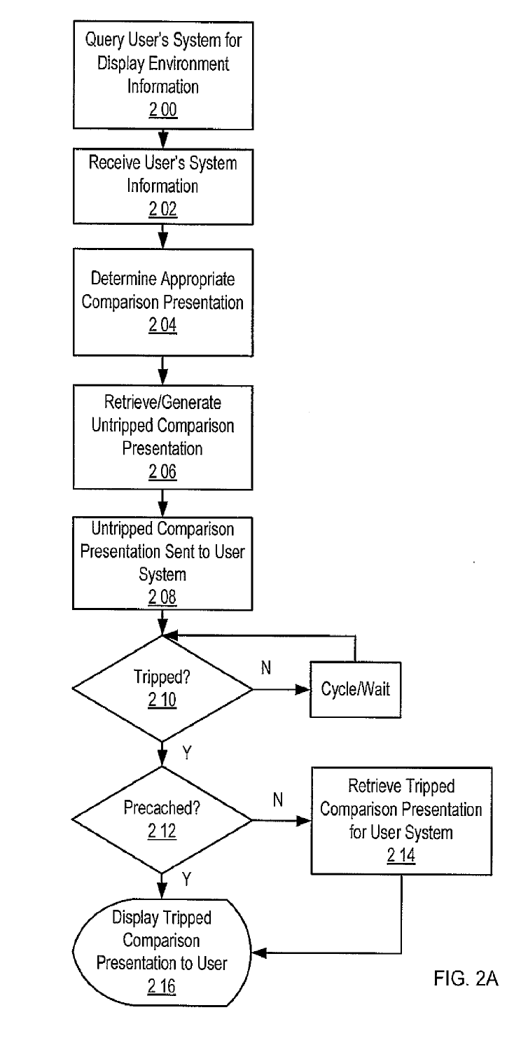

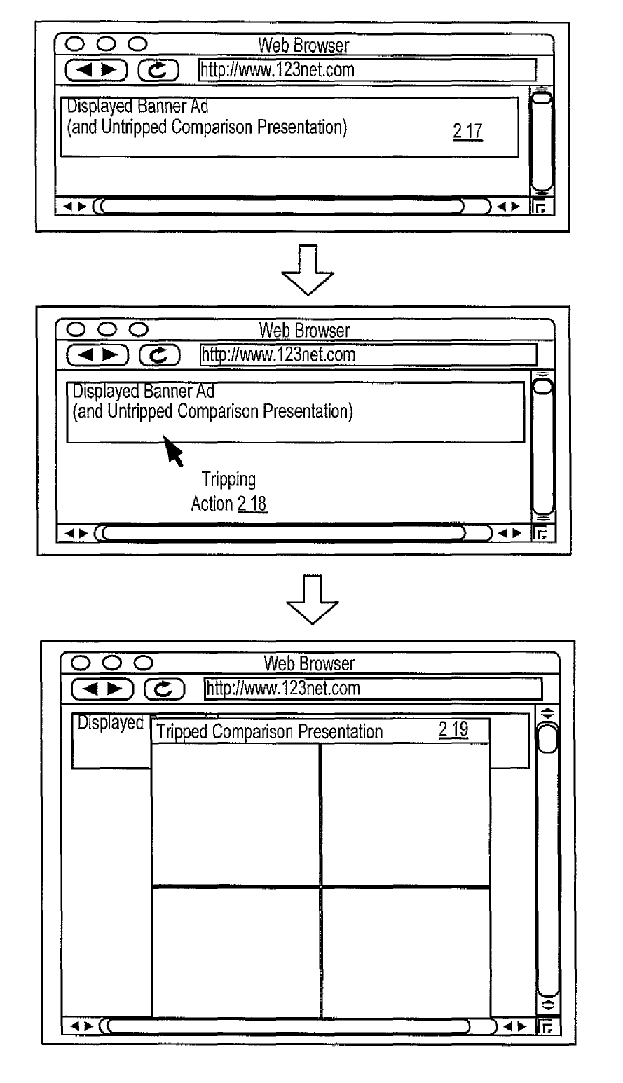

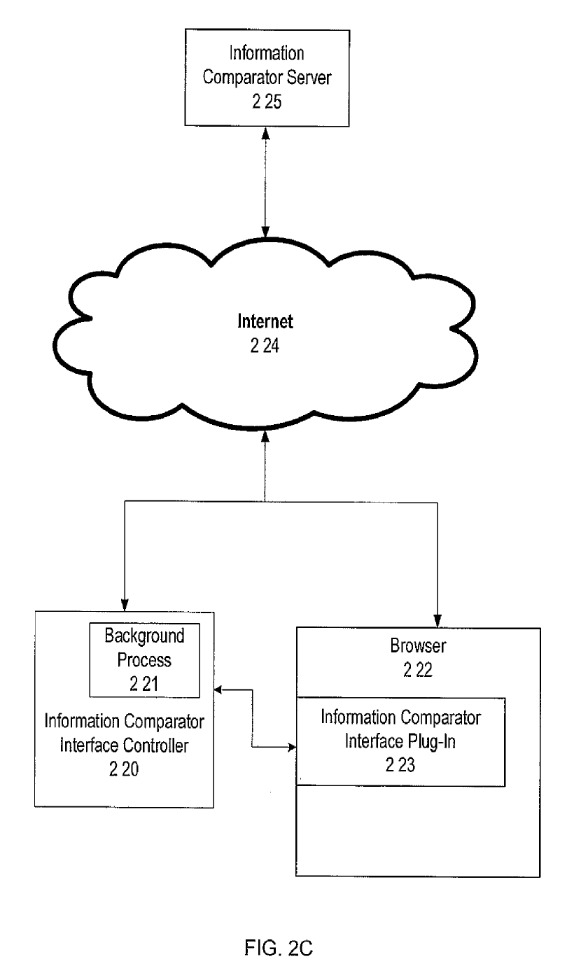

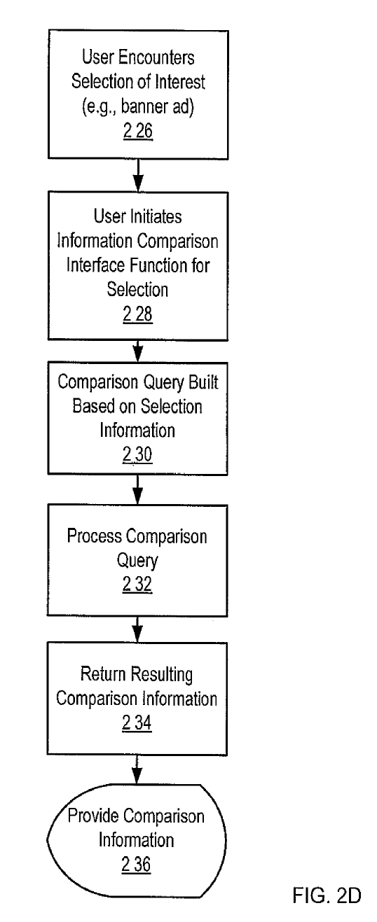

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Information Comparator Overview

For the purpose of illustrating functionality associated with the information comparator, the following discussion includes the information comparator implemented in the context of advertising. However, it is to be understood there is significant flexibility and scalability associated with the information comparator. As such, there are a wide variety of possible implementations of the information comparator that may be configured to meet the needs of a variety of end users.

FIG. 1 provides a mixed data and logic flow overview of an embodiment of the information comparator. In such embodiments, advertisers 104a-104n or similar entities may submit information items or “ads” to the information comparator 105. As shown in the figure, the information comparator 105 may tag or otherwise identify received ads (see FIG. 1C for additional detail) and store the tagged ads in an ad database 106 or the like. In one embodiment, the information comparator generates a comparison presentation 110, which in some implementation comprises information panes in which ads or other information items may be displayed (discussed in greater detail below with respect to FIGS. 1C-1D). The information comparator places the comparison presentation 110 into an ad stream 111 for subsequent presentation to a user (e.g., web user), for example, by submitting it to an ad server and/or to an ad serving service provider. It is to be understood that the information comparator may be configured to interact with a wide variety of end users. Furthermore, it is to be understood that while the following discussion of users may be within the context of web users, it is not meant to be limited to such implementations. A user may then view a page on which the comparison presentation has been loaded 112.

In one embodiment, the loaded comparison presentation may initially appear to the user as a banner ad (see FIG. 2B, ad 217), either for a general category (e.g., boats) or, alternatively, for a particular product or offering. If the comparison presentation is triggered 113 (e.g., the user clicks on or mouses over the comparison presentation), the ad database 106 may be queried for ads and/or associated ad tags corresponding to the comparison presentation 114 and/or additional information, such as site information, user information and/or the like. In one embodiment, the panes of the comparison presentation are populated with the top identified corresponding ads 115 and the comparison presentation and associated ads are displayed to the user 116. The user may then interact with the displayed comparison presentation and/or ad panes 117 and such interaction may be recorded 118.

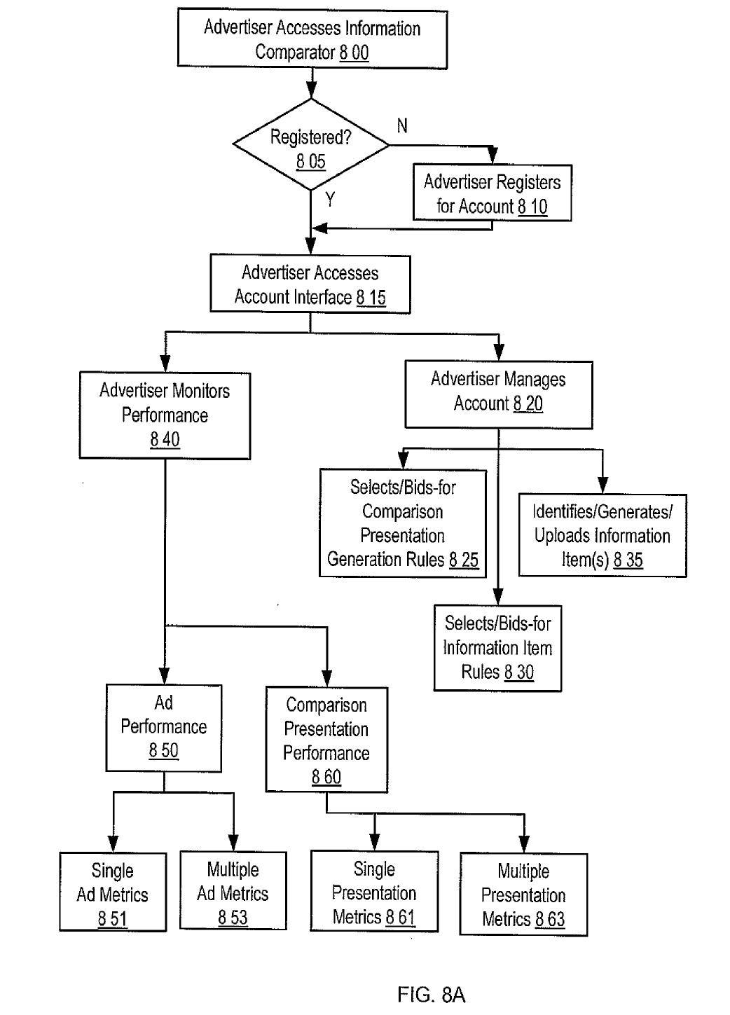

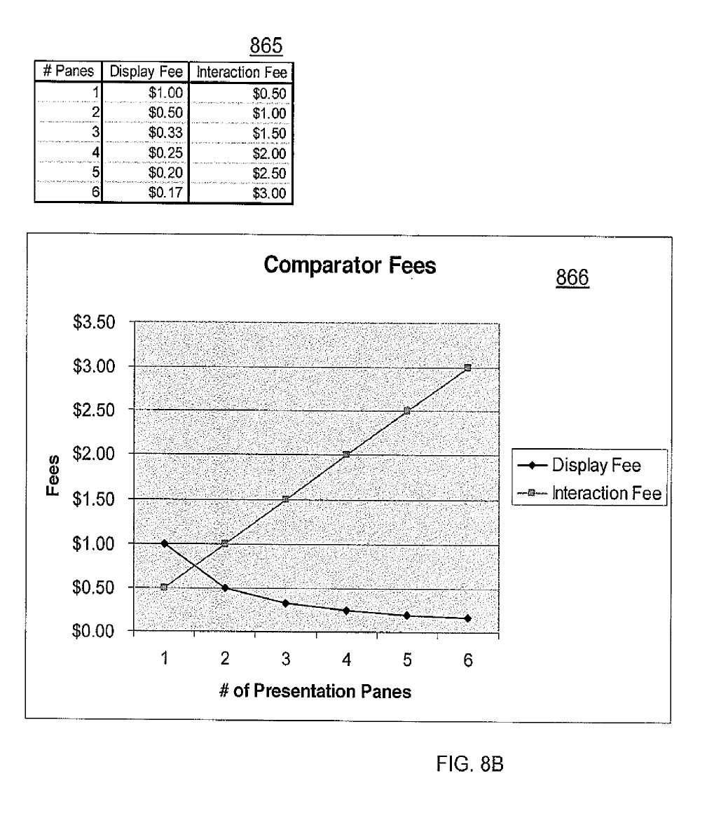

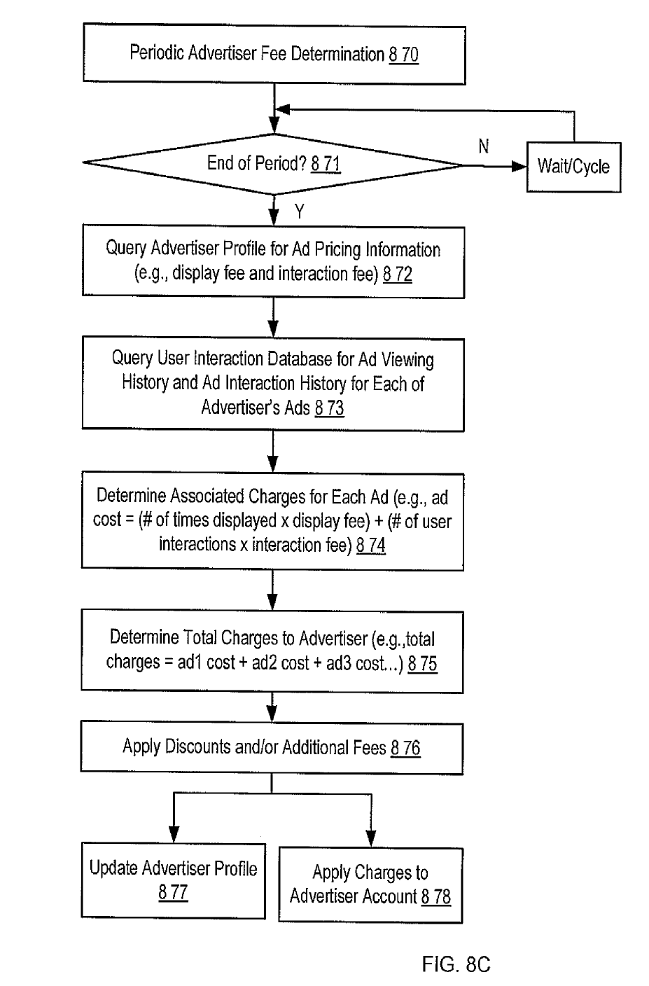

In some embodiments, advertiser(s) whose ads were displayed may be charged 119 or billed (discussed in greater details in FIGS. 8A-8C). For example, in one implementation, advertisers are charged a fee each time their ad is displayed in a comparison presentation (i.e., a “display fee”). In some embodiments, the fee may be a relatively lower or higher fee than would be charged for a single ad, for example, an advertiser may be charged according to the relative area or “real estate” of their ad within the comparison presentation (e.g., if there are four ads displayed, the fee charged for each ad would be half of the fee charged if there were only two ads displayed). Alternatively, or additionally, an advertiser may be charged a fee (i.e., a “user interaction fee”) when a user clicks through or selects their ad from a displayed comparison presentation, and/or when user interaction results in a transaction (e.g., user purchase). In some embodiments, the information comparator may include an account interface module to provide advertisers an account interface to manage preferences, payment information, tracking information, and/or bid on placement of ads (for example, as described in FIG. 8A). In one embodiment of the information comparator, an advertiser's fees may be accrued and the advertiser be billed periodically. In another embodiment, the information comparator provide an advertiser deposit module to allow an advertiser to deposit money to an associated account from which incurred fees may be debited.

FIG. 1A provides an overview of the entities involved in one embodiment of the information comparator. The information comparator 105 may interact directly and/or indirectly with a web users' systems 101 (e.g., computers and/or like systems), web servers 102, and/or other content servers, such as ad servers 103. In some embodiments, aspects of the information comparator 105 may be implemented by and/or on web users' systems 101, web servers 102 and/or ad servers 103. In certain embodiments, advertisers 104 may interact with and/or utilize the services of the information comparator 105.

The information comparator 105 may be configured so that users (e.g., web users) may request comparison presentations via provided controls on the users' system 101 (e.g., computers, cell phones, PDAs, set top boxes and/or the like). Alternatively, the information comparator 105 may dynamically provide users' systems 101, web servers 102 and/or content servers 103 with untripped comparison presentations that may be tripped by the user's action (such as a mouse over or click), web page processes, and/or the like. Generally, such requests or actions to the information comparator may be referred to as “comparison queries”. In some embodiments, additional details regarding the comparison query, such as the hardware profile, site context, user profile and/or history, demographic, psychographic, temporal and/or other types of information may be collected by the information comparator 105 and/or utilized in generating comparison query responses.

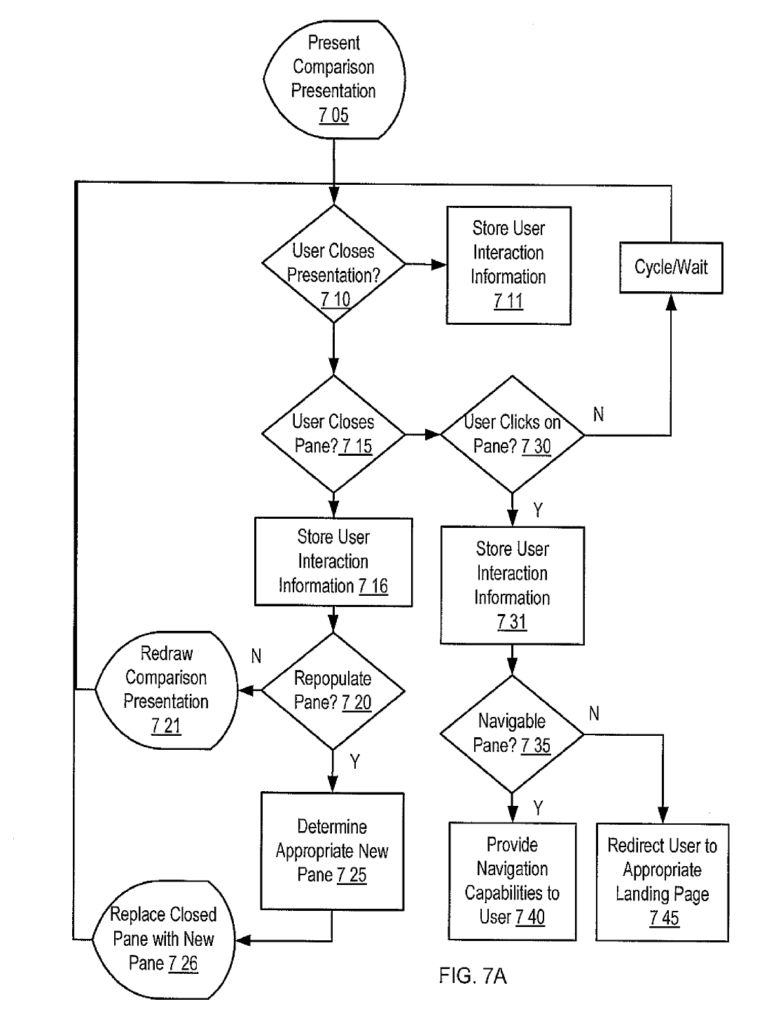

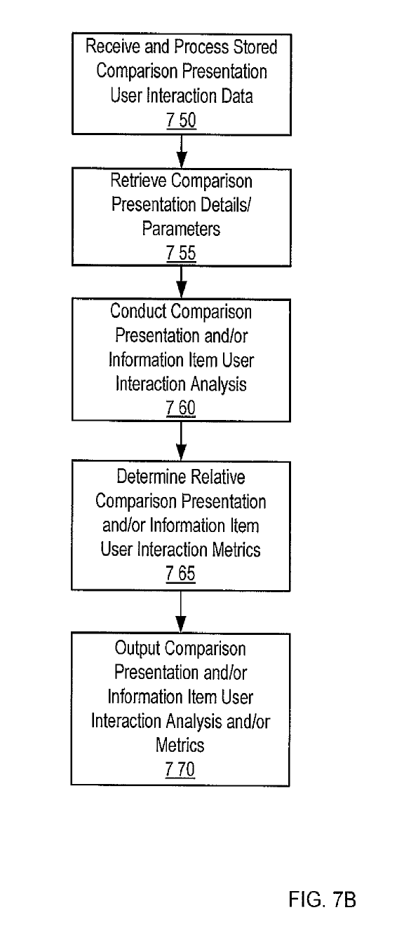

In a further embodiment, the information comparator may discern and utilize indicia regarding a particular user's language and/or location, including: browser language preference settings, operating system preference settings, IP addresses, user search and/or browsing history and associated language usage, mobile device location information (e.g., GPS coordinates for GPS-enabled handheld computing device or phone), and/or the like, for example, as described in U.S. provisional patent application No. 60/804,150 filed Jun. 7, 2006 and titled “APPARATUSES, METHODS AND SYSTEMS FOR LANGUAGE NEUTRAL SEARCH”, which is incorporated by reference. Some embodiments may use such indicia in determining and/or generating an appropriate comparison presentation and/or associated information items. For example, in some embodiments, advertisers may set rules and/or pay an associated fee to have their ad provided to a user with certain language/location indicia. In other embodiments, language and/or location indicia may be utilized by the information comparator in identifying user characteristics or attributes for subsequent analysis (e.g., demographic analysis) and/or user interaction metrics (described in detail with respect to FIGS. 7A-7B).

In one embodiment, for example, when a user navigates to a web page, the user's system 101 may transmit a request to a web server 102 requesting web page data from the web server 102. The user's system 101 may then receive web page data from the web server 102. The received web page data may include instructions for and/or calls to the source of certain elements, such as advertisements and/or the like, executed by the user's system 101 in rendering the web page. As described above, in one embodiment, a comparison presentation or like comparison interface may be provided to a user via an interactive web page element, such as, for example, a web banner, banner advertisement and/or the like. In some embodiments, the information comparator 105 provides comparison presentation(s) and/or associated ad(s) through the interaction of a user's system 101 with a web server 102 and/or ad server 103. A comparison query may be constructed, for example, based on web site context or user specific information, sent to and received by the information comparator 105 and/or other associated servers 102/103. The received query may then be utilized to generate and/or retrieve an appropriate comparison presentation and/or associated information items or ads, which is/are the sent to the user's system for display to the user.

In a further embodiment, the information comparator 105 is augmented by the participation of information item providers, such as advertisers. In one embodiment, an advertiser 104 may supply information items or ads for storage on information comparator associated servers. In an alternative embodiment, the ads may be stored on third party servers (e.g., an ad server 103) that are referenced by the information comparator 105. In some embodiments, an advertiser 104 may interact with the information comparator 105 to influence comparison presentations (e.g., via bidding on rules as discussed with respect to FIG. 8A) and/or to collect data regarding user interaction with comparison presentations and/or associated advertisements (e.g., user interaction metrics).

FIG. 1B provides an overview flow diagram for an embodiment of the information comparator. In such an embodiment, the information comparator collects information items, such as advertisements and/or web pages 120, and establishes comparison presentation rules, filters, and/or parameters 121. Depending on the embodiment, the rules, filters, and/or parameters may be general, specific, hierarchical, comparator-defined, advertiser-defined, user-defined, and/or administrator-defined. Additional detail regarding rules, filters, and/or parameters is provided in the below discussion. Using the collected information items, rules/filters/parameters and/or additional information, the information comparator generates and/or distributes comparison presentations 122. Users (e.g., web users) subsequently view and interact with the comparison presentations and/or associated information items 123, for example, by clicking on or navigating in or around the comparison presentation.

The information comparator records and manages the users' interactions 124, and also manages the comparison presentation rules, filters, and/or parameters 126.

In some embodiments, the information comparator may communicate with advertisers 123 or other entities, for example, providing user interaction information (e.g., customer behavior data) for a particular comparison presentation that included the advertiser's product or service, or contextual advertisement data for a similar product. In an implementation, the advertiser may provide additional information items to the information comparator 127 based on received user interaction information.

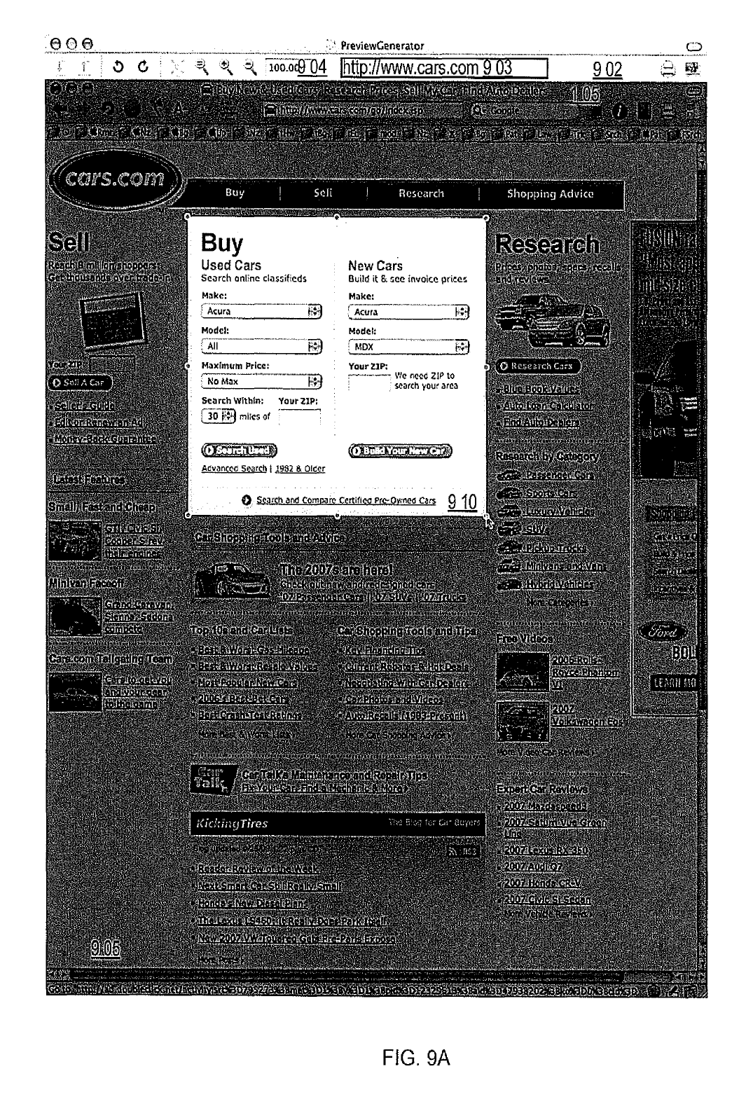

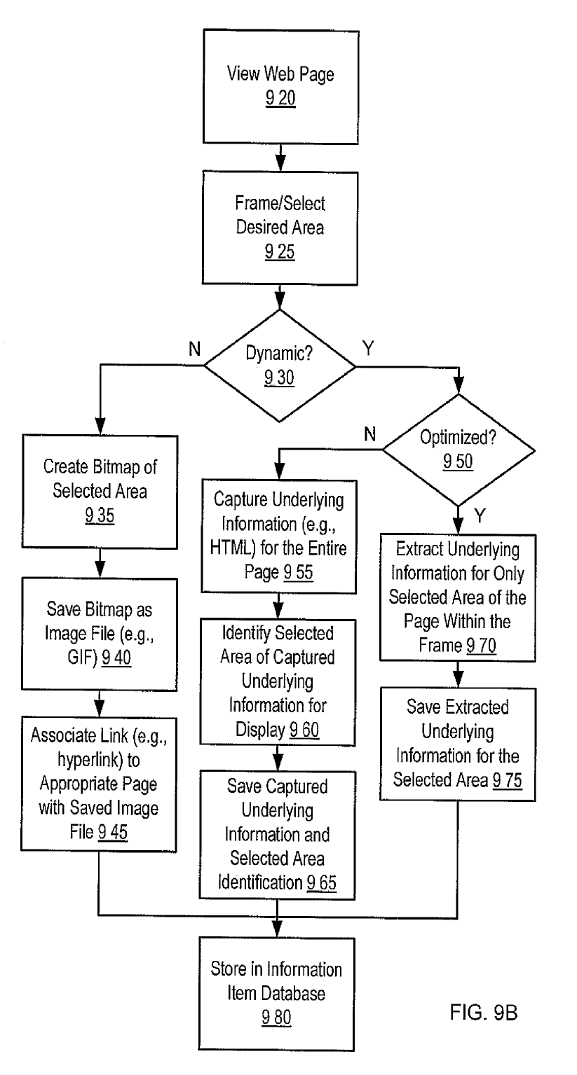

In one embodiment, the information comparator may provide an advertiser with a tool or utility to create, modify and/or add features to an information item (for example, as discussed with respect to FIGS. 9A-9B). Advertisers may also be allowed to select or indicate additional rules, filters and/or parameters 128. In one embodiment, an advertiser pays a fee to select or indicate additional rules, filters and/or parameters 128 associated with a comparison presentation and/or information item, while in another embodiment, multiple advertisers may bid to select or control certain rules, filters and/or parameters (see FIG. 8A).

FIG. 1C provides a process flow diagram detailing additional aspects of comparison presentation generation for an embodiment of the information comparator. The information comparator may collect and store information items, such as advertisements, in an information item database 130. In one embodiment, the information items may be collected by the information comparator, for example, through spidering or crawling web sites and/or advertisements in order to aggregate information items. In another embodiment, the comparator may collect, tag and/or store information items from sources including ad streams and/or ad servers. Alternatively, or additionally, the information comparator may allow an entity, such as an advertiser, to submit information items and/or ads (as described in FIGS. 1B and 8A) and/or create information items, for example, using the preview generator as described in FIGS. 9A-9B.

Depending on the implementation, the information comparator may then group, tag, and/or otherwise identify each information item 132. For example, information items may be grouped or tagged as “similar” information items. Alternatively, information items may be grouped or tagged as “dissimilar”. Accordingly, the information comparator may utilize such similar or dissimilar tags or groupings in the selection of information items for display in a comparison presentation. In one embodiment, an information item may be associated with multiple groups and/or have multiple tags, and such classifications may vary in scope. For example, an advertisement for a fishing boat may be in one of the same groupings and/or have one of the same tags as an advertisement for a ski boat (e.g., a “boat” group or tag). The fishing boat advertisement may also be in a “fishing boat” group (or subgroup) that excludes the ski boat advertisement. Additional classifications, groupings and/or tags, such as product, service, location, segment, cost, target demographic, and/or the like may also be assigned to information items.

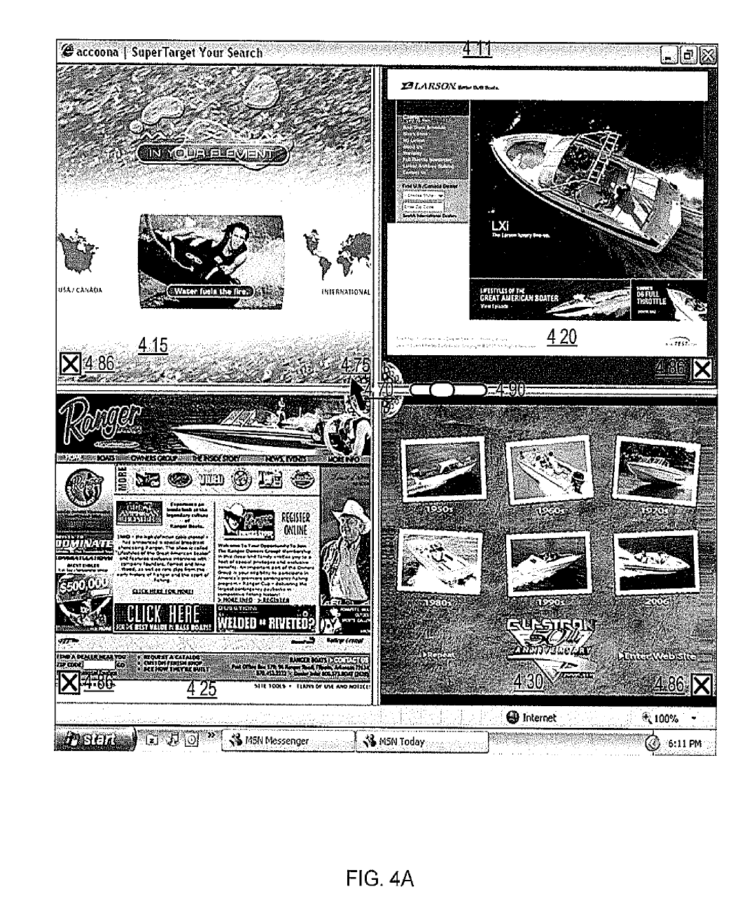

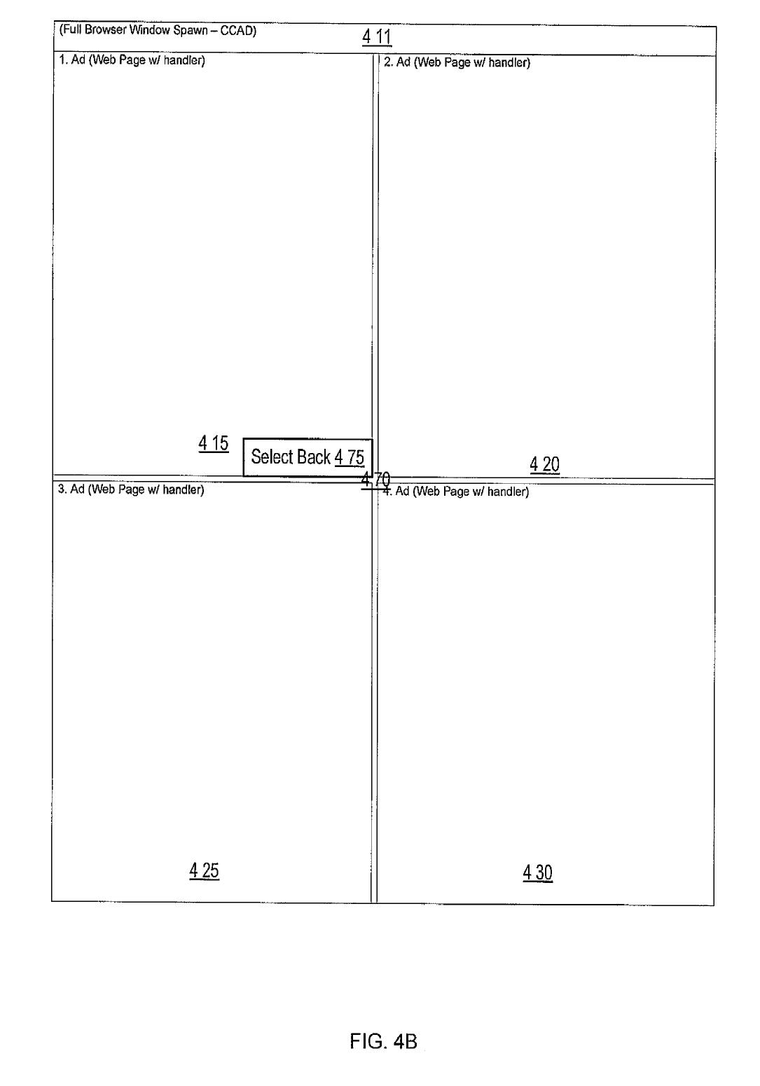

The information comparator may utilize stored information items in generating comparison presentations (examples of which are discussed in greater detail in FIGS. 4A-4B). If the comparison presentations are to be pre-generated 134, the information comparator determines if rules and/or filters exist that are to be used in generating the comparison presentation 136. For example, in one embodiment, there may be rules specifying that certain information items, groups and/or tags are not shown together or, alternatively, specifying that certain information items, groups and/or tags may be or must be shown in the same comparison presentation. Depending on the embodiment, the rules may be established by the information comparator and/or another entity, such as an advertiser. In one implementation, advertisers may pay or bid to control or set one or more of the rules or filters used in generating the comparison presentation (see discussion of FIG. 8A). In another embodiment, the rules/filters may be dynamic and respond to feedback (e.g., user interaction or behavior data collected from previous comparison presentations provided to users). If there are rules or filters 136, the information comparator identifies the applicable rules/filters and may generate one or more comparison presentations according to said rules/filters 140. If there are no established rules/filters 136, the information comparator may generate one or more default comparison presentations 138. The information comparator may then store the generated comparison presentations in a comparison presentation database 142.

As shown in FIG. 1D, which continues the flow of FIG. 1C, some embodiments of the information comparator may await receipt of a comparison query. If a comparison query is received 144, the information comparator may check the comparison presentation database 146 to determine if a stored comparison presentation (e.g., a pre-generated and/or previously used comparison presentation) matches or corresponds to parameters from the received comparison query 148. If there is at least one matching comparison presentation 148, the information comparator determines if there is more than one matching comparison presentations 150. If there is only one matching comparison presentation 150, the identified comparison presentation is transmitted in response to the comparison query 166. If there are multiple matching comparison presentations, some embodiments of the information comparator may determine if there is supplemental comparison input 152, such as: rules (e.g., advertiser-specified rules), user location data, user system information, site context information, and/or historical data. If appropriate, the information comparator may utilize such input in sorting and/or filtering the potential comparison presentations 154. If supplemental input does not exist 152, the information comparator may, in some implementations, order the matching comparison presentations according to relevance. In either situation, the information comparator then identifies the most relevant comparison presentation 156 and transmits said comparison presentation 166.

In one embodiment, if at least one matching or corresponding comparison presentation does not exist 148, the information comparator reviews the information item database to identify, order and/or rank potentially relevant information items 158. The information comparator then determines if there are applicable rules for the information items 160 and/or comparison query. If applicable rules exist, the information comparator applies the relevant rules to order or reorder the identified information items 162. The information comparator may then create a comparison presentation consisting of the top N (e.g., N=2, 3, 4, 5 . . . ) identified information items 164 and transmit the comparison presentation 166.

Comparison Presentation Database

As described above, some embodiments of the information comparator may utilize a comparison presentation database 146. In one embodiment, the comparison presentation database 146 may contain complete comparison presentations, including each comparison presentation's associated information items (e.g., ads). In another embodiment, the comparison presentation database may contain comparison presentation templates, with links and/or tag indicators identifying either specific ads or ad groups (i.e., ads with the same or similar tags) to be used or referenced when providing the comparison presentation to a user 166. In some embodiments, a comparison presentation template may be populated with tagged ads from an ad database 106. Alternatively, or additionally, ads may received from one or more ad servers or ad streams, and in some embodiments, such ads may be selected, filtered, evaluated and/or tagged dynamically by the information comparator.

In some implementations, the information comparator manages comparison presentations through processing elements of a comparison presentation data structure. In one embodiment, as shown in FIG. 1E, the comparison presentation data structure 181 is comprised of an identifier 182, layout data 183 such as comparison presentation size 184, number of ad panes (N) 185 and/or the like. The data structure may also indicate the specific comparison presentation content 186, which may include the N indicated ads 187a-187n and their associated content 188a-188n (e.g., text, images, audio, video, links and/or the like) and/or tags 189a-189n. The data structure may also contain parameters 190 indicating where and/or when an comparison presentation should be provided, including but not limited to: site context 191 (e.g., on an information technology website), location context 192 (e.g., to users in the Northeast), user demographic 193 (e.g., age/gender) and/or psychographic context (where applicable), and/or user system context 194, such as software (e.g., browser) and/or hardware specifications for the comparison presentation.

In a further embodiment, the comparison presentation data structure also includes collected user interaction data and/or statistics 195 (e.g., user interaction metrics) characterizing or describing previous user interactions with the comparison presentation and/or associated ads. Such user interaction information may be general, providing aggregated data for multiple user interactions with a particular comparison presentation and/or information item over some time period. Alternatively, or additionally, such user interaction information may be specific, providing detail for each unique user interaction with a given comparison presentation.

In one embodiment, the XML for a comparison presentation may have the following structure:

```
<Comparison_Presentation>
    <Presentation_Identifier> 123456
    </Presentation_Identifier>
    <Layout>
        <Size> scalable </Size>
        <Panes_N> 2 </Panes_N>
    </Layout>
    <Presentation_Content>
        <Info_Item_1>
            <Item_Content>
                <Text> </Text>
                <Images> imagefile12
</Images>
                <Audio> </Audio>
                <Video> </Video>
                <Links> </Links>
            </Item_Content>
            <Tags> boats, fishing, Colorado
            </Tags>
        </Info_Item_1>
        <Info_Item_2>
            <Item_Content>
                <Text> “Get your fish” </Text>
                <Images> imagefile43
</Images>
                <Audio> </Audio>
                <Video> </Video>
                <Links> </Links>
            </Item_Content>
            <Tags> boats, fishing, high performance,
Rocky Mountain Region
            </Tags>
        </Info_Item_2>
    </Presentation_Content>
    <Parameters>
        <Site_Context> Sporting, Outdoors, Fishing
Enthusiast
        </Site_Context>
        <Location_Context> Western U.S.
        </Location_Context>
        <Demographic_Context> none specified
        </Demographic_Context>
        <User_System> standard and mobile web
browsers
        </User_System>
    </Parameters>
    <Interaction_Stats> 41% of users close comparison
presentation; 19% interact with information item 1; 40%
interact with information item 2
    </Interaction_Stats>
</Comparison_Presentation>
```

FIG. 2A shows a flow diagram associated with an implementation of the information comparator in which the information comparator 105 queries a user's system 101 (e.g., a web user's system) for display environment information 200 (e.g., hardware and/or software constraints) and/or other information. Based on the response to the system information query 202, the information comparator 105 selects an appropriate comparison presentation 204 and/or information items or ads to be provided to the user's system 101. For example, the comparison presentation to be provided to a user's cell phone may be different from the comparison presentation to be provided to a user's personal computer. In a further embodiment, additional information, such as user characteristics, web page data, search parameters, and/or profile information, may also be requested from about user's system 101 and/or web server 102, and said information used in determining appropriate comparison presentations. For example, the comparison presentation selected for a user located in California browsing a video game website could be different than the comparison presentation selected for a user in New York browsing a financial news website.

Additional embodiments may further customize and/or optimize comparison presentations to users by the incorporation of user preferences and/or supplemental user information (e.g., demographic, psychographic, historical and/or like data). The above collected user information may additionally or alternatively be utilized by the information comparator in determining user interaction metrics (as discussed in detail in FIGS. 7A-7B). Such embodiments may incorporate a user login/registration procedure. A user may log in directly with the information comparator, for example, logging in to an information comparator website, or indirectly, for example, logging in to another service, such as email or browser toolbar login. In an alternative or additional embodiment, user tracking/identification tools (e.g., HTTP cookies or web bugs) may be utilized to establish, track and/or update basic user information.

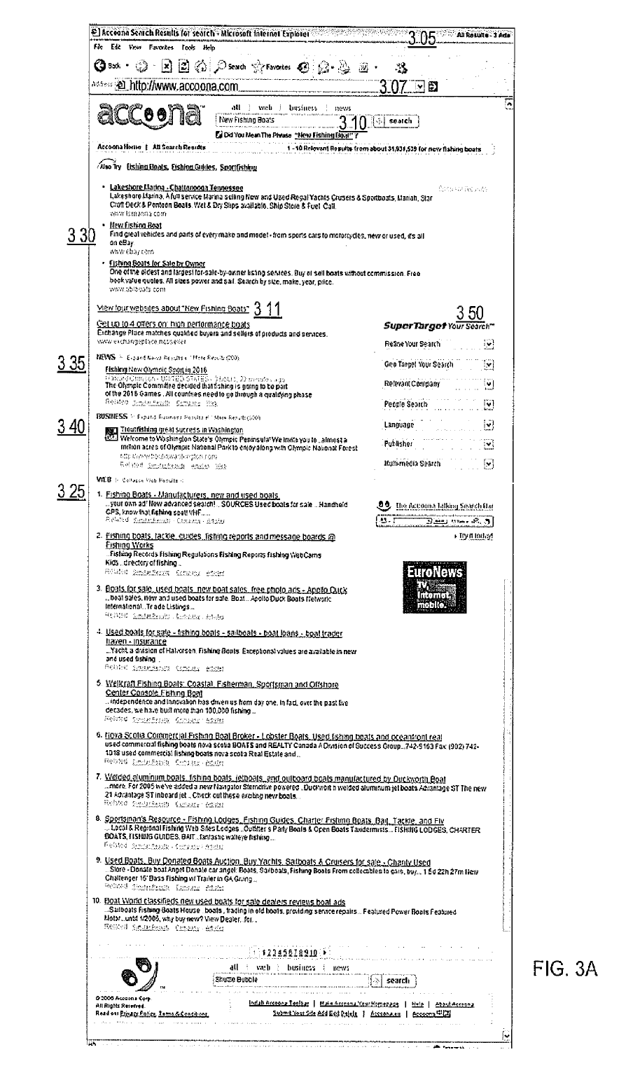

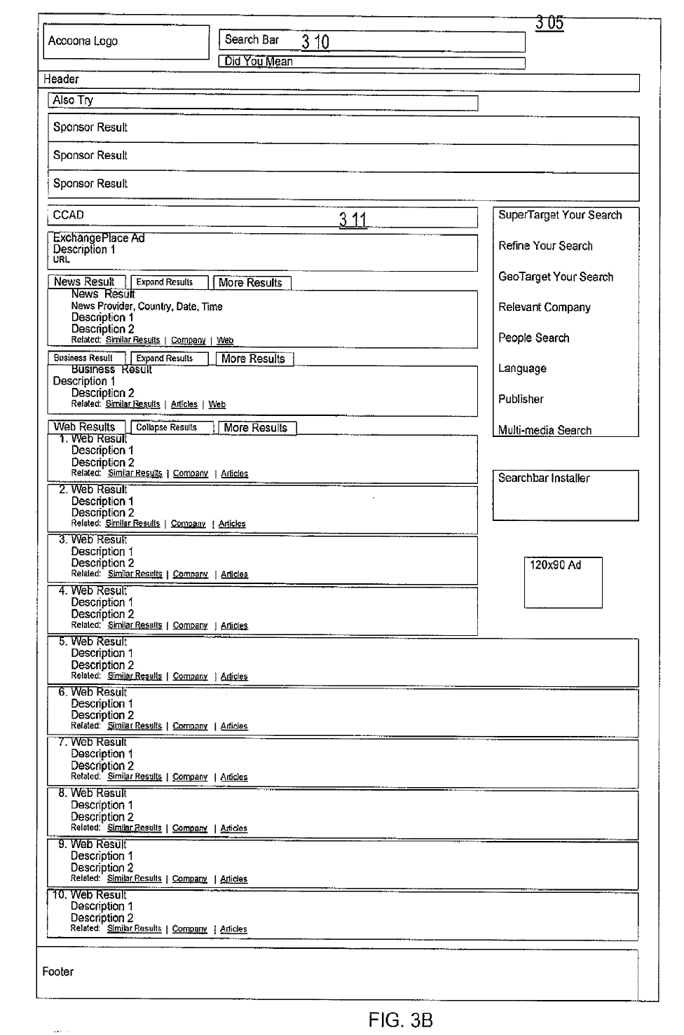

Once the information comparator has determined an appropriate comparison presentation 204, the information comparator retrieves and/or generates a corresponding untripped comparison presentation 206, which is transmitted to the user's system 208. In one embodiment, the comparison presentation may include instructions to be executed on the user's system (e.g., JavaScript and/or AJAX). For example, the information comparator and/or comparison presentation can then check for a tripping action 210, and if there is none, cycles and rechecks. In one embodiment, a loaded untripped comparison presentation may be tripped by user interaction such as a user mousing over a banner ad associated with the comparison presentation (see FIG. 2B) or a user engaging a provided information comparator engagement component (see FIG. 3A for additional detail). If the comparison presentation has been tripped 210 (e.g., clicked) and the tripped comparison presentation is pre-cached 212, the tripped comparison presentation is displayed 216. If the tripped comparison presentation is not pre-cached 212, the comparison presentation is retrieved 214 and displayed to the user 216.

FIG. 2B illustrates an example of an implementation in which a comparison presentation is implemented as part of a banner ad. As illustrated, the banner ad and associated untripped comparison presentation 217 are incorporated as part of a web page displayed to a user. As discussed above, a tripping action 218, for example, a user mousing over or clicking an engagement component and/or banner ad, trips the comparison presentation and the tripped comparison 219 is displayed to the user 216. In some embodiments, the details provided in FIGS. 4A-7 may also apply to the above described embodiments of the information comparator.

In some embodiments, the information comparator provides a user (e.g., web and/or end user) interface which may be customized and/or configured for a particular user and/or for a specific implementation. In one embodiment, the information comparator is configured to interact with software applications, such as web browsers, and provides users with a dynamically modifiable user interface with features for facilitating access to and control of comparison information. In one embodiment, the user interface may be incorporated into software applications as a plug-in component by using various Application Programmer Interfaces (APIs). These implementation may employ a modular and extensible architecture wherein different components of the user interface may be instantiated and uninstantiated based on the context of operation and/or the needs of the user.

Plug-in

In one embodiment, the information comparator is implemented as a web browser plug-in that may be saved in a directory in which web browsers store plug-ins. When a web browser is loaded, the information comparator plug-in may be loaded along with the web browser. As such, the plug-in may be incorporated as an additional element within the browser, such as, for example, a browser toolbar or the like. In another embodiment, the user interface is provided within the context of a web page accessed using the browser.

FIG. 2C discloses an overview of one embodiment of the information comparator in which the main user interface for the information comparator is configured as an information comparator interface controller 220. The information comparator and/or associated components can be implemented using a variety of software development techniques. For example, the information comparator can be implemented as a stand-alone application or a web-based application. The information comparator could be implemented using software techniques as required by the hardware platform(s) on which it runs, including, by way of non-limiting example, an entertainment console, personal digital assistant, phone, set-top box, and the like.

The information comparator interface controller 220 allows the user to utilize the functions of the information comparator, such as accessing and controlling comparison information and/or comparison interface features and tools. For example, in one implementation, the information comparator may provide an information comparison tool (e.g., via a right-click information comparison function) that allows a user to request comparison information (e.g., competing ads) for user specified data, such as a displayed banner advertisement.

In one embodiment, the information comparator interface controller 220 may connect to the internet 224 or other network to receive information concerning comparisons and/or the user, such as a user's history, profile and/or preferences. In some embodiments, an information comparator server 225 may be provided to manage/store comparison information and data. In another embodiment, the information comparator server 225 may alternatively or additionally manage/store a user's preferences, settings and/or characteristics.

The information comparator interface controller 220 may also interact with an information comparator interface plug-in 223. The information comparator interface plug-in 223 provides a mechanism for information to be transferred to and from the information comparator interface controller 220. In one embodiment, a particular comparator interface feature or tool might be accessed or generated thorough the use of a web browser 222 or other host application with which the information comparator interface plug-in 223 is integrated, in order to provide added functionality. In this way, when a new process is started in the browser 222 the information comparator interface plug-in 223 provides a user interface and communication infrastructure to communicate the relevant information about the new process to the information comparator interface plug-in 223. The information comparator interface plug-in 223 can similarly request relevant information from the information comparator interface controller 220, such as the user's settings and characteristics, accessible to the host browser 222.

In some embodiments, a unique instance of the information comparator may be provided for a user by having a local version of the information comparator on the user's systems (e.g., personal computer or the like). A version of the information comparator may be accessed remotely by a user or users. In some embodiments, users might be provided a unique instance of the information comparator via user accounts with usernames and passwords, where a user's unique instance of the information comparator stores relevant user specific information such as settings and characteristics, and in a further embodiment, provides access to customized applications, features and tools to a particular user.

In one implementation of the embodiment shown in FIG. 2C, the information comparator interface plug-in 223 integrates with the user's browser 222 to provide a mechanism to transfer information between the information comparator and the browser. In some embodiments, in order to allow the information comparator to receive, store and/or transfer information when the information comparator interface controller 220 is not actively running, a background process 221 is provided to supply a connection interface for the information comparator interface plug-in 223. The background process could be embodied, for example, as a daemon or like process. In some embodiments, the information may be stored on the network accessible information comparator server 225 that may be accessed by the information comparator interface plug-in 223 and/or information comparator interface controller 220.

FIG. 2D provides a flow diagram of an interface aspect for one embodiment of information comparator. In such an embodiment, when a user encounters an advertisement or other item of interest 226 while browsing, for example a banner ad for an electric razor, the user may initiate the information comparison interface feature 228 (e.g., via the provided right click functionality as described above). A comparison query may then be built based on the selected item 230 (e.g., the banner ad). The query may include information from the ad, web page, user characteristics and/or the like. The query is processed 232 and the resulting comparison information is returned 234 and presented to the user 236. In one implementation, the provided comparison information includes information regarding other types of items, such as other brands or models of electric razors. In another implementation, the provided comparison information may include competing retailers offering the selected product.

Engagement

FIG. 3A is a screen image diagram illustrating an interface aspect of one embodiment of the information comparator. A web browser 305 has been navigated to a search engine (e.g., www.accoona.com) that implements a version of the information comparator. Upon navigating to the search engine, a user provided input as a search term in a search box 310, in this case for “New Fishing Boats.” The search engine obtained the search tokens from the user via http post commands via the user's web browser and/or like mechanism. In one embodiment, an artificial intelligence enhanced search engine as has been described in applicants' PCT patent application serial no. PCT/05/20545 filed Jun. 10, 2005 and titled “Apparatus, Method and System of Artificial Intelligence for Data Searching,” may be used to obtain the query tokens and return search results 325.

In addition to the search results, the search engine may employ the information comparator to serve the user with a comparison presentation of information items related to the user's search token 311. In one embodiment, the information comparator may take a given number of results that are most related to one another and present them for comparative viewing 311 along with any related search results 325, ads 330, news 335, and/or business information 340. It should be noted that the navigation and refinement of such related and returned information may be enhanced with search navigators 350 as has been described in applicants' U.S. provisional patent application No. 60/805,698 filed Jun. 23, 2006 and titled “Apparatuses, Methods and Systems to Generate, Display and Use a Search Enhancing Navigator.”

If the user engages (e.g., clicks) the information comparator engagement component 311, which in this case is a text link, it will trigger the retrieval of the comparative information. In one embodiment, the comparative information may be based the top N search results (e.g., when N=4, the comparison presentation provides information items associated with the first four listed search results, for example, a miniaturized screen shot of each page). In another embodiment, the selection of comparative information (e.g., the generation and/or information item population of a comparison presentation) may be based on the search term entered by the user. For example, in the above case where a user entered the search terms “new fishing boats”, the information comparator may query an ad database for ads tagged with fish, fishing, boat, fishing boat, new boat, new fishing boat, and/or similar tags, and populate a comparison presentation with the most relevant ads. In yet another embodiment, the comparison information may be based on a user's selection of one of the returned search results (e.g., aspects of the selected search result could be incorporated into a subsequent comparison query). It should be noted that the engagement component may be any kind of hyperlink such as a textual hyperlink, a graphical hyperlink, a banner ad, embedded multimedia (e.g., video (Windows Media Video, QuickTime, Real Video, Flash, etc.), audio, graphic, hypertext (HTML, dynamic HTML (DHTML), Asynchronous JavaScript and XML (AJAX), and/or the like)), and/or the like. It should be further noted that while the information comparator is well-suited to serving comparative advertising information, it also may be adapted for the comparison of numerous types of information. In particular, the simultaneous presentment of related and/or competing information to a user wherein the user can register information preferences and navigation informatics tracking occurs, such presentment allows for the enhanced building of information relation topologies as disclosed in applicants' PCT patent application serial no. PCT/05/20545 filed Jun. 10, 2005 and titled “Apparatus, Method and System of Artificial Intelligence for Data Searching.” Similarly, FIG. 3B is of a wire frame diagram illustrating embodiments of the information comparator engagement component.

Selection

FIG. 4A is a screen image diagram illustrating aspects of an information comparator selection component. Upon the user triggering the information comparator engagement component 311, a user's web browser will load and present the user with a comparison presentation (i.e., a preview of related and/or competing information 411). In one embodiment, the engagement component 311 is a hyperlink linking to the server address of the information comparator with an identifier that will retrieve the search related items. In one embodiment, the engagement component embeds the user's original search tokens. In another embodiment, the engagement component 311 contains a unique session identifier that will be used to find the related information on the information comparator server. In such an embodiment, the search engine may refine the relatedness (e.g., similarity/dissimilarity) of information. This may be achieved from when the user provided the original search tokens 310 until the user triggers the engagement component 311. In another embodiment, related information may be cached at the server for retrieval.

The information comparator may instantiate a comparison presentation or preview selection component (“preview selector”) 411 in a number of ways. The preview selector includes a number of panes, each having comparative information, 415, 420, 425, 430, and various navigation and control widgets 470, 475, 486, 490. In one embodiment, AJAX is used so that the preview selector overlays the current web page 310, 410. As shown in FIG. 4B, the preview selector fills the user's entire web browser viewing area with an overlay containing previews 415, 420, 425, 430 of comparative information (e.g., information items).

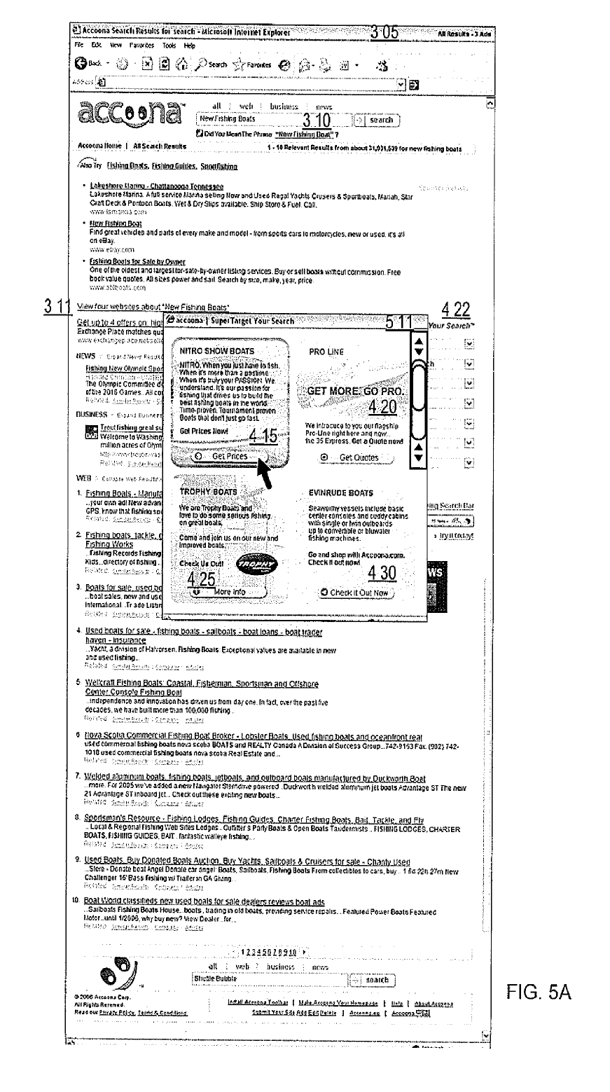

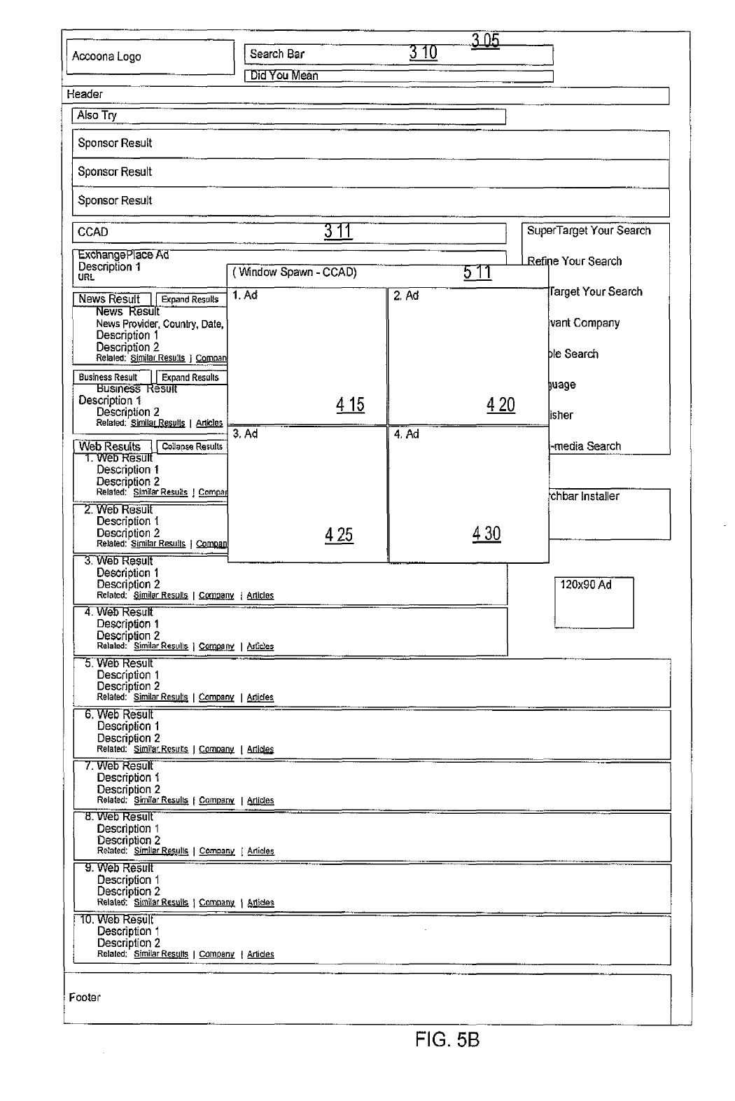

In an alternative embodiment, a new single browser window is spawned containing previews 415, 420, 425, 430 of the comparative information (see 511 of FIGS. 5A and 5B). In another embodiment, multiple browser windows or tabs are spawned, each holding one or more items of comparative information. In some embodiments, the preview selector may be sized to meet the requirements or needs of users and/or advertisers. In one embodiment, the preview selector may grow to take up the user's full screen space. In another embodiment, the preview selector will grow a specified amount. In yet another embodiment, the preview selector will not grow; it may even be shrunk. Numerous sizing and positions may be employed.

Although FIG. 4A shows four items of comparative information (e.g., fishing boat related information), the information comparator may provide 1, 2, 3, 4, 5, or more, etc. comparative items of information. The information items are presented in comparative information panes. In one embodiment, a slider widget 490 may accompany the preview selector that allows the user to increase or decrease the number of comparative panes dynamically. Accordingly, the user may increase or decrease the number of information items that are displayed. In addition, the user may engage a widget to dismiss 486 a pane within the preview selector. In one embodiment, the dismissal widget is a close box widget 486 and is overlaid on the information item 415, 420, 425, 430. By engaging the close widget 486, the user may “prune” the comparative information down to view only on items of interest; e.g., if the user is initially shown four panes of comparative information, the user may close two of the panes with the close box and then navigate through those two panes to make further comparative assessments. In one embodiment, a restore widget may be provided to allow user's to restore a dismissed pane, in one implementation via tracking and displaying a user-navigable listing of panes presented and closed. In another embodiment, the closed pane(s) may be dynamically replaced with new pane(s). In a further embodiment, the new pane(s) is/are determined using information regarding the relationship between the pane(s) which were closed and those which were not. For example, if the user closed panes which provided ads for boats with inboard motors, and the remaining panes provided ads for boats with outboard motors, the new panes may be selected to only include ads for boats with outboard motors. Numerous other comparative presentations are contemplated as being within the scope of this disclosure.

Navigation

In one embodiment, the preview selector component 411 is navigable. In such an embodiment, each of the panes includes fully navigable information. In one embodiment, a navigation selector 475 may be placed and/or overlaid on each of the information panes and/or items 470. For example, where each pane includes (D)HTML, a user may select hyperlinks in any of the panels and the panel will act like a “mini web browser.” This will allow the user to navigate through multiple comparative information sources simultaneously in each pane of the preview selector; all without ever leaving the original web page they were navigating.

Once presented with the preview selector 411, the user may review the presented comparative information. For example, in the case where the comparative information is comprised of four advertisements, the user may decide to select 475 an advertisement (e.g., “Water fuels the fire”) 415 by selecting the information in one of the comparative information panes 415. It should be noted that while providing navigation in the preview selector component 411 is useful in many contexts, in other contexts all that is needed is a preview 411 as discussed in greater detail in FIGS. 9A-9B. FIG. 4B provides a wire frame diagram illustrating embodiments of the information comparator selection component.

Enlargement

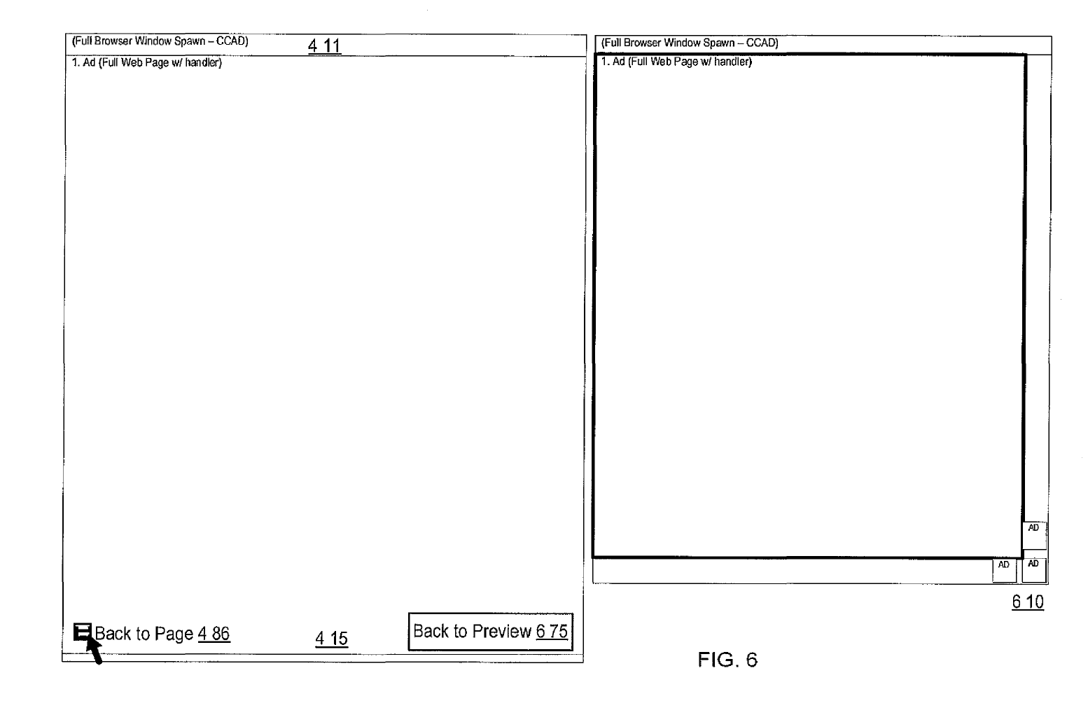

FIG. 6 is of a wire frame diagram illustrating embodiments of the information comparator with an enlarged view. By engaging a navigation selector 675, the user may enlarge any one of the numerous comparative information panes and/or items. Upon the user engaging a navigation selector 675, a selected information item may change its comparative position to one of prominence (as shown in FIG. 6). It should be noted that in such an embodiment, although the information item may be re-sized to take up the entire web browser pane and/or window, the original web page being viewed by the user may be maintained so that if the user decides to dismiss the comparative information items, the user's previous web browsing position may be maintained. In another embodiment, the original web page may be dismissed. In yet another embodiment, engaging the navigation selector 675 may result in spawning a new web browser page based on the information item. By re-sizing the selected information item to a visual position of prominence, it allows a user to navigate the information item with greater freedom and focus. The user may engage a widget to dismiss the information comparator selector component 411, 486. In one embodiment, when the information comparator selector component is in a spawned window, the user may simply use the window's close box widget to dismiss the window. In another embodiment, a close box widget is overlaid on the information item 486. In addition, a user may engage the navigation selector 675 again to restore the information comparator selector component 411 to the status quo ante as was illustrated in FIGS. 4A and 4B. In an alternative embodiment, when a user enlarges an information item or pane, the enlargement may take up most of the web browser space but leave a residual space into which ads may be placed 610.

FIG. 7A provides an interaction flow diagram for an embodiment of the information comparator interface. The preview selector component 411 (from FIG. 4A) or like comparison presentation is provided to the user 705, as discussed above. If the user closes the comparison presentation 710, the action may be recorded and the user interaction information stored 711. If a user closes one or more panes 715 (e.g., by engaging the close widget 486) the user interaction information is stored 716. If the information comparator interface is set to not repopulate closed pane(s) 720, the comparison presentation may be redrawn to include only the remaining items of interest 721, as described above. Alternatively, if the information comparator interface is set to repopulate the closed pane 720, the appropriate new pane may be determined 725 and used to replace the closed pane 726.

In one embodiment, the new panes are selected based on the relationship between the pane(s) which were closed and the panes which remain open. For example, if the user closed panes for advertisements for luxury boats and low end boats, but did not close panes for mid-range boats, the new panes may be selected from ads for mid-range boats. In some embodiments, the above process may be iterated to further refine the provided information comparison. If there is no user interaction 730, the information comparator may cycle/wait for additional interaction or may close the panes and/or preview selector after a set time has elapsed. If a user does click on or interact with a pane 730, the user's action is recorded 731. As described previously, in some embodiments, the comparison presentation (e.g., preview selector component 411) is navigable. If the pane is navigable 735, navigation capabilities, such as those described above, may be provided to the user 740. If the pane is not navigable 735, the user may be directed to a landing page associated with the information item in the pane 745, for example, via a hyperlink.

Relevant information, such as the ads presented and the corresponding relationships, additional user information, and/or interaction information (e.g., amount of time the selector component or an individual ad was displayed before being closed) may also be collected and recorded. Such information may be used to improve the performance of the preview selector component and/or the individual ads. The collected information may also be valuable to advertisers interested in gauging customer interest in and/or response to the comparison information and/or targeting certain users. FIG. 7B provides a flow diagram illustrating one aspect of user interaction analysis for an embodiment of the information comparator. The stored comparison presentation user interaction data is received and processed 750 and the associated comparison presentation details and/or parameters are retrieved 755. Based on the user interaction data and retrieved comparison presentation information, the information comparator may then perform a user interaction analysis 760 and determine user interaction metrics 765. The information comparator may then output (e.g., to advertisers) user interaction analysis reports and/or user interaction metrics 770, for example, providing them to an advertiser as part of an account interface (as discussed in FIG. 8A).

For example, in one embodiment, the information comparator may conduct a covariance determination for collected user interaction information and associated comparison presentation data and/or information item or ad data, in some embodiment outputting such information as a user interaction report and/or performance metrics. In some embodiments, such metrics may be provided to advertisers or like entities, and/or used in generating/refining comparison presentations, comparison queries or responses, and/or pricing services associated with the information comparator. The information comparator may receive and process stored user interaction data 750 to determine primary user interaction metrics. Auxiliary information, including information item details, comparison presentation details, and/or additional user information, corresponding to the stored user interaction information may also be retrieved 755 (e.g., the details regarding the comparison presentation and/or associated information items with which the user interacted). For example, this information may be retrieved from a comparison presentation database. From the primary user interaction metrics and retrieved auxiliary information, a comparison presentation and/or information item covariance analysis and/or metric(s) may be determined 765. In some embodiments of the information comparator, the covariance analysis and/or metric(s) may be associated with an advertiser's profile and/or associated comparison presentation data.

In some embodiments, each user selection, interaction and/or click may be recorded when a user navigates or makes comparative selections within comparison presentations. These user activities may be tracked, stored, and subsequently used for numerous comparative analytics. As users navigate between comparative information items and/or sources, the users' selections as between and among comparative information items may be analyzed for correlations, associations, preferences, and/or the like and employed to further refine information ontologies, such as described in applicants' PCT patent application serial no. PCT/05/20545 filed Jun. 10, 2005 and titled “Apparatus, Method and System of Artificial Intelligence for Data Searching,” thereby enhancing future information associations. For example, where four information items are provided to a user, and the user commonly navigates around one web page in a first information item, yet, navigates deeper to another web page in a second information item, a confidence rating corresponding to an association between the commonly navigated items may be strengthened in the search ontology and/or incorporated into determining user interaction metrics.

Information comparator-determined user interaction metrics, for example, aggregated interaction metrics, may provide insight into the relationship between ads and/or associated user/consumer behavior. These types of metrics may be of value to advertisers or other entities, such as marketing strategy organizations. In one embodiment, information comparator-determined interaction metrics may include consumer decision process information and/or consumer preference information. Furthermore, interaction metrics may include product or service positioning information. For example, by tracking users' interactions with an advertiser's ad relative to competing ads, the determined interaction metrics may provide details about how consumers view the advertiser's product, service, and/or the ad itself, relative to competing ads. In one embodiment, the information comparator may utilize user/consumer behavior, historical, demographic, psychographic and/or like information in determining interaction metrics. For example, in one embodiment, the information comparator may determine metrics indicating that a certain ad is preferred over other ads within a comparison presentation when said comparison presentation is presented to users browsing a particular website (such as a general news website). However, the information comparator may recognize the same ad may not be preferred by users over competing ads when the comparison presentation is presented on another website (such as a financial news website).

Advertiser Interface

In some embodiments, the information comparator may provide an interface for advertisers to utilize and interact with certain features of the information comparator. FIG. 8A provides a process flow diagram illustrating an aspect of advertiser interaction for an embodiment of the information comparator. An advertiser accesses the information comparator 800, for example, via a provided comparator website, and may be prompted to login. If the advertiser has not registered with the information comparator 805, the advertiser may be prompted to register/create an account 810, for example, providing contact and/or billing information. In some embodiments, the information comparator may create an advertiser profile and populate the profile with information provided by the advertiser and/or subsequent user interaction information.

The information comparator may then allow registered advertisers to access an advertiser account interface 815. From the provided interface, an advertiser may manage an information comparator account 820. In some embodiments, the information comparator may provide a selection and/or bidding module to allow advertisers to bid for or otherwise select comparison presentation generation rules 825 (e.g., rules directing the process for determining which comparison presentation will be provided in response to a particular comparison query) and/or information item rules 830 (e.g., how information items are displayed and/or arranged in a particular comparison presentation). The information comparator may also provide a module to allow advertisers to identify, generate, upload and/or otherwise manage ads or information items 835 (e.g., the preview generator described in FIGS. 9A-9B).

Some embodiments of the information comparator may also provide a performance module allowing an advertiser to monitor the performance of ads 840 from various levels of detail. For example, in one embodiment, the performance module may allow an advertiser to determine the performance of ads 850, reviewing either performance metrics for an individual ad 851 or multiple ads 853. In some embodiments, the performance module may allow an advertiser to review comparison presentation performance 860, for example, by providing metrics for single 861 or multiple 863 comparison presentations. In a further embodiment, the information comparator may generate system-wide performance reports and/or metrics, which may be made available to advertisers.

As described above, some embodiments of the information comparator may be implemented as a vehicle for comparative advertising, and as such, may utilize numerous revenue models. In one embodiment, a flat rate is charged for displaying the ads most related to a given topic (e.g., comparison query). In another embodiment, advertisers may bid for placement of given topics, inputs, and/or contexts, with the top bidders' ad placements presented to users (e.g., via a comparison presentation). In a further embodiment, advertisers' bids may be utilized in determining the arrangement and/or location of the ad as presented to users. For example, if the comparison display is a 2×2 grid (e.g., as described in FIGS. 4A and 4B), the winning bidder may be assigned to the upper left corner, or alternatively may be given first choice in selecting ad placement within the presented comparison, and the second highest bidder given second choice, and so forth.

In some embodiments, the information comparator may utilize multi-part pricing (e.g., as illustrated by FIG. 8B, which provides an example fee table 865 and corresponding graph of fees 866). In the embodiment shown in the figure, the fee an advertiser is charged when an ad is displayed to a user (e.g., via a comparison presentation) may decrease according to the number of other ads included in the comparison presentation (i.e., advertisers pay for the area or “real estate” within the comparison presentation). In a further embodiment, the display fee may be further determined or augmented by the placement of the ad within the comparison presentation. For example, if the panes of the comparison presentation are arranged in a 2×2 grid, the upper left pane may have the highest fee and the lower right pane may have the lowest fee. In one embodiment, advertisers may bid-on or otherwise select the number of panes (N) that are associated with a comparison presentation that displays their ad. In another embodiment, display parameters such as the number of panes (N) and/or the inclusion/exclusion of certain ads may be driven by the information comparator.

FIG. 8B also illustrates an interaction fee utilized in some embodiments of the information comparator. When a user interacts with, engages, or navigates (e.g., clicks, browses and/or the like) an ad in a displayed comparison presentation, the interaction may be recorded and the corresponding advertiser charged for the user interaction or navigation. As shown by the figure, a user interaction or navigation fee may be charged to the advertiser based on the number of other ads in the comparison presentation. Although the display fee is lower when the comparison presentation includes more ads, the interaction or navigation fee may be higher, depending on the implementation. Advertisers targeting particular types of consumers and/or trying to optimize their advertising budget may find such an implementation particularly appealing as it provides a relatively low cost per view by consumers (i.e., if the ad is displayed with other ads as part of a comparison presentation). The advertiser only pays the higher price for users who are most interested in their service or product (i.e., users who select the advertiser's ad from multiple similar ads).

In another embodiment, the information comparator may provide a bidding module allowing advertisers to pay for and/or bid on rules relating to presenting comparative information. For example, advertisers may bid to have their ads presented with another ad. Alternatively, or additionally, advertisers may bid to prevent their ad from being presented with another ad. In some implementations, fees and/or prices may be based, updated and/or modified according to user interaction metrics and/or other performance metrics. Numerous other revenue and advertising models are also contemplated as being within the scope of this disclosure. For example, the information comparator may be coupled to the bidding model presented in PCT patent application serial no. PCT/US06/13873 filed Apr. 12, 2006 titled “Apparatuses, Methods And Systems To Identify, Generate, And Aggregate Qualified Sales And Marketing Leads For Distribution Via An Online Competitive Bidding System.”

In some embodiments, the information comparator may store an advertiser's bids, ads, and/or associated user interaction data in a generated advertiser profile (e.g., as described in the registration process of FIG. 8A above). In some embodiments, the content of the advertiser profile generated by the information comparator may itself be a novel data structure. For example, in one embodiment, the XML for the advertiser profile may take the following form:

```
<Advertiser_Profile>
    <Advertiser_Name> ABC Recreation </Advertiser_Name>
    <Advertiser_ContactInformation> John Smith,
    jsmith@.abc_recreation.net
    </Advertiser_ContactInformation>
    <Advertiser_BillingInformation>
        <Account_No> 12345678 </Account_No>
        <Billing_Term> weekly billing </Billing_Term>
    </Advertiser_BillingInformation>
    <Advertiser_Ads>
        <Ad1>
            <Ad1_Name> Hi-Tech Sports Fishing Boat
            </Ad1_Name>
            <Ad1_Content> (text, images, video, audio, links, URLs
and/or the like)
            </Ad1_Content>
            <Ad1_Tags>
                <Tag1> Boating </Tag1>
                <Tag2> Fishing </Tag2>
                <Tag3> Outdoor Sports </Tag3>
                <Tag4> Colorado </Tag4>
            </Ad1_Tags>
            <Advertiser_Specified_Rules> Do not show with “Budget
Fisherman King Boat” advertisements
            </Advertiser_Specified_Rules>
            <DisplayBid> $0.25 per display </DisplayBid>
            <InteractionFee> $0.75 per user </InteractionFee>
            <CurrentDisplayHistory> 13843 user views
            </CurrentDisplayHistory>
            <CurrentUserInteractionHistory> 3899 user interactions
            </CurrentUserInteractionHistory>
            <UserInteractionAnalysis> [Additional Data Needed]
            </UserInteractionAnalysis>
        </Ad1>
    </Advertiser_Ads>
</Advertiser_Profile>
```

The fees or charges associated with an advertiser may calculated continuously and/or periodically by the information comparator, depending on the implementation. In some embodiments, the information comparator may include an information comparator billing module to manage charges and bill advertiser appropriately (e.g., using one or a combination of the above disclosed pricing or bidding methods).

FIG. 8C provides a flow diagram illustrating periodic advertiser fee determination 870 in an embodiment of the information comparator. The information comparator billing module determines if it is the end of the specified advertiser billing period 871 (e.g., as defined in the advertiser's profile), and if not, waits and cycles. At the end of the period, the information comparator billing module may query the advertiser's profile to determine the associated ad pricing information 872 (e.g., the advertiser's display fee(s) and interaction fee(s) as described in FIG. 8B). The billing module may then determine the user interaction information associated with the advertiser's ad(s). For example, by querying the user interaction database 873, the billing module may determine user viewing history, user interaction history, and/or corresponding metrics for each of the advertiser's ad(s). The billing module may determine each ad's associated charges 874 (e.g., display fee multiplied by the number of displays plus the interaction fee multiplied by the number of interactions). The billing module may then determine the total ad charges 875 (e.g., summing all the individual ad charges) and apply any discounts and/or additional fees 876. In some embodiments in which advertisers bid on rules or the like, there may be a periodic or flat fee associated with the rule. Alternatively, a fee may be charged for each time a rule is implemented by the information comparator. In such embodiments, these fees may also be incorporated into an advertiser's fee determination by the billing module. The information comparator and/or billing module may then update the advertiser's profile and/or apply the determined charges to said advertiser's account.

Preview Generator

Embodiments of the information comparator may provide an information comparator preview generator to generate preview displays of selected information. The preview generator may, in some embodiments, allow sources (e.g., advertisers, creators, owners, and/or operators of websites hosting content) to generate information items. For example, in one implementation, the information comparator preview generator could be provided as a tool or utility that allows advertisers and/or the like to select, create and/or generate information items from existing media, such as web sites. The information items may then be stored and used in subsequent comparison presentations provided to users, as described above.

FIGS. 9A and 9B provide a screen image and process flow diagram, respectively, illustrating aspects of some embodiments of the information comparator preview generator. FIG. 9A illustrates an embodiment in which the preview generator is a modified web browser 902 which allows an advertiser or like entity to specify an initial source of content 903 (e.g. www.cars.com). The specified source of content 905 (i.e., web page) will render within the bounds of the preview generator page. Various tools may be supplied to allow the advertiser to increase/decrease the displayed area of the page 904, rotate the page, and/or otherwise manipulate aspects of the rendered page.

In one embodiment, an advertiser or other information source (e.g., creators, owners, and/or operators of sites hosting content) may be provided access to the features of the preview generator by accessing a provided account interface 815 and use those feature to generate information items 835 (FIG. 8A). As shown in FIG. 9B, a user (such as a registered advertiser) may view a particular page 920 and select or “frame” the desired area or region of the page 925 by using the preview generator. An example of this is shown as element 910 of FIG. 9A.

In one embodiment, if the comparison presentation, comparison pane and/or information item is not dynamic 930 (i.e., navigable), the Preview Generator may make a bitmap and/or take a snapshot of a desired region 935. In one embodiment, the bitmap and/or snapshot is saved as an image or graphic file (e.g., GIF, JPG, PNG, etc.) format 940. A link (e.g., hyperlink) to the appropriate page, such as the source page or other appropriate landing page, may be associated with the saved image file 945, such that if a viewer of the image file (e.g., a user/customer viewing a comparison presentation and/or comparison pane that includes the image file) clicks or selects the image, they are directed to the appropriate page (i.e., via the hyperlink). The image file, associated link, and/or other information representative of the content may then be stored in an information item database 980.

In one embodiment, if the comparison presentation, comparison pane and/or information item is dynamic 930 (i.e., navigable), but not optimized 950, the preview generator may capture the underlying information (e.g., HTML) for the entire page 955, identify the selected/framed area of the page 960, and save the underlying information and display selected area identification 965 for use in rendering the area in the preview selector. The saved information and identification, along with any additional information representative of the content, may then be stored in an information item database 980. In one embodiment, if the preview is optimized 950, the Preview Generator captures 970 and saves 975 only the underlying information for the selected or framed area of the page. The information and any additional representative information is stored in an information item database 980.

In one embodiment, such a preview or information item is saved as being representative of an ad. In another embodiment, where the information is from a web site and/or advertiser, the content owner may make a custom web page for preview. In another embodiment, the information comparator generates a “miniature” image of an entire specified landing page for the information provider. This embodiment may be a default embodiment when a content provider does not specify or otherwise provide a preview or information item. In yet another embodiment, the entire site is presented in whole. For example, each pane may have scrollers 422 of FIG. 4A for navigation through the entirety of the page.

### Information Comparator Controller

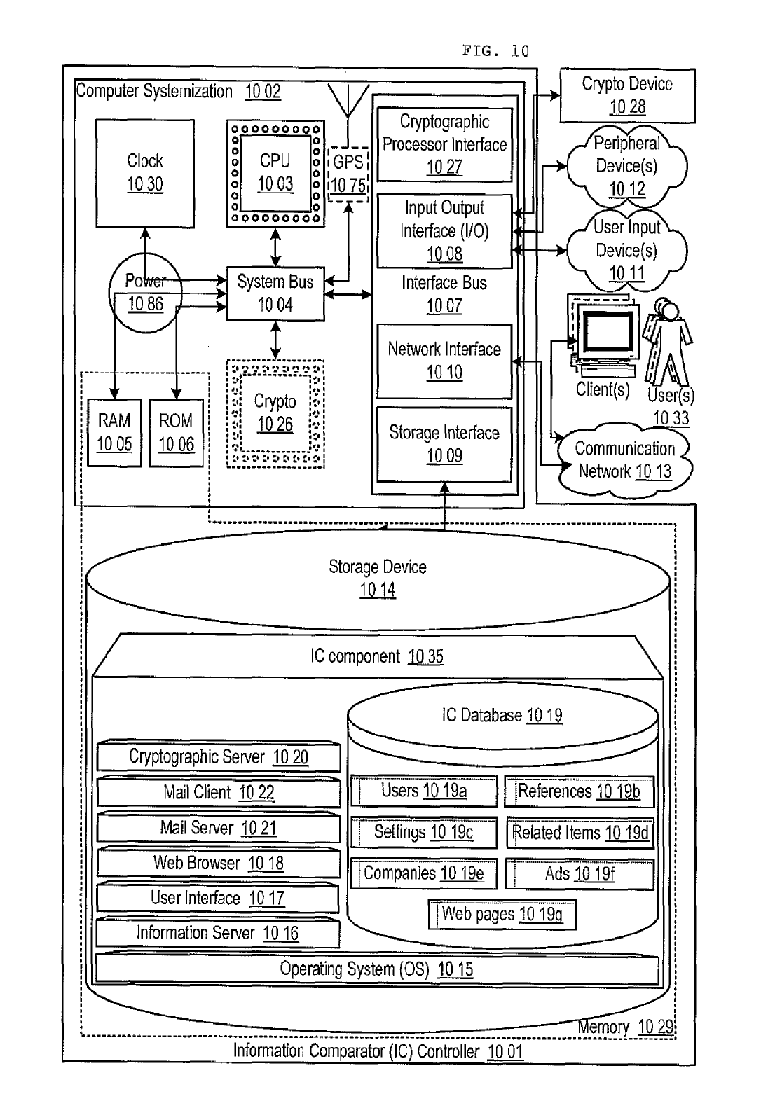

FIG. 10 of the present disclosure illustrates inventive aspects of an Information Comparator controller 1001 in a block diagram. In this embodiment, the Information Comparator controller 1001 may serve to aggregate, process, store, search, serve, identify, instruct, generate, match, and/or facilitate comparative interactions with information, and/or other related data.

Typically, users, which may be people and/or other systems, engage information technology systems (e.g., commonly computers) to facilitate information processing. In turn, computers employ processors to process information; such processors are often referred to as central processing units (CPU). A common form of processor is referred to as a microprocessor. CPUs use communicative signals to enable various operations. Such communicative signals may be stored and/or transmitted in batches as program and/or data components facilitate desired operations. These stored instruction code signals may engage the CPU circuit components to perform desired operations. A common type of program is a computer operating system, which, commonly, is executed by CPU on a computer; the operating system enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through a database program. Information technology systems provide interfaces that allow users to access and operate various system components.

In one embodiment, the Information Comparator system controller 1001 may be connected to and/or communicate with entities such as, but not limited to: one or more users from user input devices 1011; peripheral devices 1012; a cryptographic processor device 1028; and/or a communications network 1013.

Networks are commonly thought to comprise the interconnection and interoperation of clients, servers, and intermediary nodes in a graph topology. It should be noted that the term “server” as used throughout this disclosure refers generally to a computer, other device, program, or combination thereof that processes and responds to the requests of remote users across a communications network. Servers serve their information to requesting “clients.” The term “client” as used herein refers generally to a computer, other device, program, or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Information Comparator system controller 1001 may be based on common computer systems that may comprise, but are not limited to, components such as: a computer systemization 1002 connected to memory 1029.

Computer Systemization

A computer systemization 1002 may comprise a clock 1030, central processing unit (CPU) 1003, a read only memory (ROM) 1006, a random access memory (RAM) 1005, and/or an interface bus 1007, and most frequently, although not necessarily, are all interconnected and/or communicating through a system bus 1004. Optionally, the computer systemization may be connected to an internal power source 1086. Optionally, a cryptographic processor 1026 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s). The CPU interacts with memory through signal passing through conductive conduits to execute stored signal program code according to conventional data processing techniques. Such signal passing facilitates communication within the Information Comparator system controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

Power Source

The power source 1086 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 1086 is connected to at least one of the interconnected subsequent components of the Information Comparator system thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE 1394 connection carries both data and power across the connection and is therefore a suitable source of power.

Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 113, the Information Comparator system controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices 1011, peripheral devices 1012, cryptographic processor devices 1028, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set 145, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1011 may be card readers, dongles, finger print readers, gloves, graphics tablets, joysticks, keyboards, mouse (mice), remote controls, retina readers, trackballs, trackpads, and/or the like.

Peripheral devices 1012 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Information Comparator system controller may be embodied as an embedded, dedicated, and/or monitor-less (i.e., headless) device, wherein access would be provided over a network interface connection.

Cryptographic units such as, but not limited to, microcontrollers, processors 1026, interfaces 1027, and/or devices 1028 may be attached, and/or communicate with the Information Comparator system controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 40 MHz Roadrunner 184.

Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the Information Comparator system controller and/or a computer systemization may employ various forms of memory 1029. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 1014 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); an array of devices (e.g., Redundant Array of Independent Disks (RAID)); and/or other devices of the like. Thus, a computer systemization generally requires and makes use of memory.

Component Collection

The memory 1029 may contain a collection of program and/or database components and/or data such as, but not limited to: operating system component(s) 1015 (operating system); information server component(s) 1016 (information server); user interface component(s) 1017 (user interface); Web browser component(s) 1018 (Web browser); database(s) 1019; mail server component(s) 1021; mail client component(s) 1022; cryptographic server component(s) 1020 (cryptographic server); the Information Comparator system component(s) 1035; and/or the like (i.e., collectively a component collection). These components may be stored and accessed from the storage devices and/or from storage devices accessible through an interface bus. Although non-conventional program components such as those in the component collection, typically, are stored in a local storage device 1014, they may also be loaded and/or stored in memory such as: peripheral devices, RAM, remote storage facilities through a communications network, ROM, various forms of memory, and/or the like.

Operating System

The operating system component 1015 is an executable program component facilitating the operation of the Information Comparator system controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the Information Comparator system controller to communicate with other entities through a communications network 1013. Various communication protocols may be used by the Information Comparator system controller as a subcarrier transport mechanism for interaction, such as, but not limited to: multicast, TCP/IP, UDP, unicast, and/or the like.

Information Server

An information server component 1016 is a stored program component that is executed by a CPU. The information server may be a conventional Internet information server such as, but not limited to Apache Software Foundation's Apache, Microsoft's Internet Information Server, and/or the. The information server may allow for the execution of program components through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the Information Comparator system controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the Information Comparator system database 1019, operating systems, other program components, user interfaces, Web browsers, and/or the like.

Access to the Information Comparator system database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Information Comparator system. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Information Comparator system as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface component 1017 is a stored program component that is executed by a CPU. The user interface may be a conventional graphic user interface as provided by, with, and/or atop operating systems and/or operating environments such as Apple Macintosh OS, e.g., Aqua, GNUSTEP, Microsoft Windows (NT/XP), Unix X Windows (KDE, Gnome, and/or the like), mythTV, and/or the like. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 1018 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program components through facilities such as Java, JavaScript, ActiveX, and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Information Comparator system enabled nodes. The combined application may be nugatory on systems employing standard Web browsers.

Mail Server

A mail server component 1021 is a stored program component that is executed by a CPU 1003. The mail server may be a conventional Internet mail server such as, but not limited to sendmail, Microsoft Exchange, and/or the. The mail server may allow for the execution of program components through facilities such as ASP, ActiveX, (ANSI) (Objective-) C (++), CGI scripts, Java, JavaScript, PERL, pipes, Python, WebObjects, and/or the like. The mail server may support communications protocols such as, but not limited to: Internet message access protocol (IMAP), Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the Information Comparator system.

Access to the Information Comparator system mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 1022 is a stored program component that is executed by a CPU 1003. The mail client may be a conventional mail viewing application such as Apple Mail, Microsoft Entourage, Microsoft Outlook, Microsoft Outlook Express, Mozilla Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 1020 is a stored program component that is executed by a CPU 1003, cryptographic processor 1026, cryptographic processor interface 1027, cryptographic processor device 1028, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Information Comparator system may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the Information Comparator system component to engage in secure transactions if so desired. The cryptographic component facilitates the secure accessing of resources on the Information Comparator system and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The Information Comparator Database

The Information Comparator database component 1019 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Information Comparator database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Information Comparator database is implemented as a data-structure, the use of the Information Comparator database 1019 may be integrated into another component such as the Information Comparator component 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 1019 includes several tables 1019a-g. A users table 1019a includes fields such as, but not limited to: a user name, ip_address, email address, address, profile, user_id, and/or the like. The user table may support and/or track multiple entity accounts on an Information Comparator. A references table 1019b includes fields such as, but not limited to: keywords, any media, datastructure, datatype, reference address, and/or the like. A settings table 1019c includes fields such as, but not limited to: settings_id, browser_language, operating_system_language, desired_current_language, desired_number_of_comparison_pages, desired_prominance_of_comparative_panes, and/or the like. A related items 1019d includes fields such as, but not limited to: keywords, synonyms, antonyms, related words, root words, related web page address, any media, datastructure, datatype, and/or the like. A companies table 119e includes fields such as, but not limited to: company name, address, URL, phone number, any media, datastructure, datatype, reference address, and/or the like. An ads table 119f includes fields such as, but not limited to: company name, address, phone number, account number, payments, ads, information items, comparison presentations, any media, datastructure, datatype, reference address, and/or the like. A web pages table 1019g includes fields such as, but not limited to: identifier_id (e.g., web address, digital object identifier, etc.), source_id, date, and/or the like.

In one embodiment, the Information Comparator system database may interact with other database systems. For example, employing a distributed database system, queries and data access by Information Comparator system component may treat the combination of the Information Comparator system database, an integrated data security layer database as a single database entity.

In one embodiment, user programs may contain various user interface primitives, which may serve to update the Information Comparator system. Also, various accounts may require custom database tables depending upon the environments and the types of clients the Information Comparator system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 1019a-g. The Information Comparator system may be configured to keep track of various settings, inputs, and parameters via database controllers.

The Information Comparator system database may communicate to and/or with other components in a component collection, including itself, and/or facilities of the like. Most frequently, the Information Comparator system database communicates with the Information Comparator system component, other program components, and/or the like. The database may contain, retain, and provide information regarding other nodes and data.

The Information Comparator

The Information Comparator component 1035 is a stored program component that is executed by a CPU. The Information Comparator affects accessing, obtaining and the provision of information, services, transactions, and/or the like across various communications networks.

The Information Comparator component enables and provides a straightforward, unified, and transparent interface that automatically presents users with a comparison of related and/or competing information.

The Information Comparator system component enabling access of information between nodes may be developed by employing standard development tools such as, but not limited to: (ANSI) (Objective-) C (++), Apache components, binary executables, database adapters, Java, JavaScript, mapping tools, procedural and object oriented development tools, PERL, Python, shell scripts, SQL commands, web application server extensions, WebObjects, and/or the like. In one embodiment, the Information Comparator system server employs a cryptographic server to encrypt and decrypt communications. The Information Comparator system component may communicate to and/or with other components in a component collection, including itself, and/or facilities of the like. Most frequently, the Information Comparator system component communicates with the Information Comparator system database, operating systems, other program components, and/or the like. The Information Comparator system may contain, communicate, generate, obtain, and/or provide program component, system, user, and/or data communications, requests, and/or responses.

Distributed Information Comparator System

The structure and/or operation of any of the Information Comparator system node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the Information Comparator system controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

1. A processor-implemented method for creating user-generated preview displays for comparison, comprising:
providing a preview generation browser to a user,
wherein the preview generation browser is a modified web browser;
providing navigation controls to the user, said navigation controls allowing the user to specify an initial content source,
wherein the specified initial content source is a web page;
rendering the initial content source within the preview generation browser;
providing content manipulation tools to the user, said manipulation tools allowing the user to manipulate the appearance and characteristics of the rendered initial content source,
wherein the content manipulation controls include frame controls, said frame controls allowing the user to frame the desired display area of the rendered initial content source;
providing a save preview control to the user, said save preview control allowing the user to save the manipulated rendered initial content source as a preview display,
wherein the manipulated rendered initial content is saved as a bitmap,
wherein the bitmap is a bitmap of the framed desired display area,
wherein the bitmap is associated with a link to the specified initial content source; and
storing the preview display in a preview display database.

2. A processor-implemented method for creating user-generated preview displays for comparison, comprising:
providing a preview generation browser to a user;
providing navigation controls to the user, said navigation controls allowing the user to specify an initial content source;
rendering the initial content source within the preview generation browser;
providing content manipulation tools to the user, said manipulation tools allowing the user to manipulate the appearance of the rendered initial content source;
providing a save preview control to the user, said save preview control allowing the user to save the manipulated rendered initial content source as a preview display; and
storing the preview display in a preview display database.

3. The method of claim 2 wherein the preview generation browser is a modified web browser.

4. The method of claim 2 wherein the specified initial content source is a web page.

5. The method of claim 2 wherein the content manipulation controls include frame controls, said frame controls allowing the user to frame the desired display area of the rendered initial content source.

6. The method of claim 2 wherein the content manipulation controls include display area controls, said display area controls allowing the user to increase/decrease the desired display area of the rendered initial content source.

7. The method of claim 2 wherein the manipulated rendered initial content is saved as a bitmap.

8. The method of claim 2 wherein the preview display is navigable.

9. The method of claim 2 wherein the preview display includes HTML.

10. The method of claim 9 wherein the included HTML is based on HTML of the initial content source.

11. The method of claim 10 wherein the included HTML comprises all the HTML of the initial content source.

12. The method of claim 10 wherein the included HTML comprises selected HTML of the initial content source.

13. The method of claim 12 wherein the selected HTML is the HTML of the manipulated rendered initial content source.

14. The method of claim 2 wherein a link is associated with the preview display.

15. The method of claim 14 wherein the link is a link to the initial content source.

16. The method of claim 2 wherein the preview display is an information item.

17. The method of claim 2 wherein the preview display is an ad.

18. The method of claim 2 wherein the user is an advertiser.

19. The method of claim 2 wherein the user is charged a fee.

20. The method of claim 2, further comprising:
accumulating a plurality of preview displays in the preview display database;
identifying comparable preview displays within the preview display database;
generating a comparison presentation that includes at least two comparable preview displays; and
providing the comparison presentation for viewing.

21-80. (canceled)
